(19) United States
(12) Patent Application Publication
(10) Pub. No.: US 2023/0058241 A1
(43) Pub. Date: Feb. 23, 2023

(54) Ink Jet Ink Composition And Recording Method

(71) Applicant: SEIKO EPSON CORPORATION, Tokyo (JP)

(72) Inventor: Yuta ASAKAWA, Azumino (JP)

(21) Appl. No.: 17/864,473

(22) Filed: Jul. 14, 2022

(30) Foreign Application Priority Data
Jul. 15, 2021 (JP) 2021-117028

(51) Int. Cl. C09D 11/322; C09D 11/38; C09D 11/36; B41M 5/00

(52) U.S. Cl. CPC C09D 11/322; C09D 11/38; C09D 11/36; B41M 5/0017

(57) ABSTRACT

An ink jet ink composition which is a water-based ink, includes: a colorant; a resin; a water-soluble low molecular weight organic compound A which is one of an amide, a sulfur-containing compound, and a cyclic ether and which satisfies the following condition (a) and condition (b); and a silicone-based surfactant which satisfies the following condition (c). The condition (a) is that a surface tension of an aqueous solution at a concentration of 10 percent by mass is 42 to 56 mN/m, the condition (b) is that a standard boiling point is 150° C. to 300° C., and the condition (c) is that a solubility in water at 20° C. is 1 percent by mass or less.

The present application is based on, and claims priority from JP Application Serial Number 2021-117028, filed Jul. 15, 2021, the disclosure of which is hereby incorporated by reference herein in its entirety.

### BACKGROUND

### 1. Technical Field

The present disclosure relates to an ink jet ink composition and a recording method.

### 2. Related Art

Since an ink jet method is able to form an image having a high quality on a recording medium, heretofore, various technical developments thereof have been carried out. For example, besides a development of a recording apparatus using an ink jet method, a development of an ink jet ink composition used for the above recording apparatus has also been actively performed. Furthermore, various types of problems caused by combination of a recording apparatus, an ink jet ink composition, a recording medium, and the like have also been tried to be overcome.

For example, JP-A-2018-134801 has disclosed a recording method in which an ink jet ink composition containing a resin component is applied to a recording medium having irregularity, and a nitrogen-containing solvent is contained in the ink jet ink composition to dissolve the resin component so as to improve an abrasion resistance.

However, it has become to understand that when a solvent to dissolve the resin component in the ink jet ink composition is used, depending on the type of solvent, a sufficient abrasion resistance may not be obtained.

Furthermore, it has also become to understand that when a solvent to dissolve the resin component is used, color development of an image to be obtained becomes worse.

As described above, an ink jet ink composition capable of forming an image having preferable abrasion resistance and color development property has not been sufficiently satisfied.

### SUMMARY

According to an aspect of the present disclosure, there is provided an ink jet ink composition which is a water-based ink, the ink composition comprising: a colorant; a resin; a water-soluble low molecular weight organic compound A which is one of an amide, a sulfur-containing compound, and a cyclic ether and which satisfies the following condition (a) and condition (b); and a silicone-based surfactant which satisfies the following condition (c). In the ink jet ink composition described above, the condition (a) is that a surface tension of an aqueous solution at a concentration of 10 percent by mass is 42 to 56 mN/m, the condition (b) is that a standard boiling point is 150° C. to 300° C., and the condition (c) is that a solubility in water at 20° C. is 1 percent by mass or less.

According to another aspect of the present disclosure, there is provided a recording method comprising an ink adhesion step of adhering the ink jet ink composition described above to a recording medium by an ink jet method.

### BRIEF DESCRIPTION OF THE DRAWINGS

FIG. 1 is a schematic view showing one example of an ink jet recording apparatus used in a recording method of an embodiment.

FIG. 2 is a schematic view of a carriage and its vicinity of one example of the ink jet recording apparatus used in the recording method of the embodiment.

FIG. 3 is a block diagram of one example of the ink jet recording apparatus used in the recording method of the embodiment.

FIG. 4 is a flowchart showing one example of a process performed for recording by the ink jet recording apparatus used in the recording method of the embodiment.

### DESCRIPTION OF EXEMPLARY EMBODIMENTS

Hereinafter, embodiments of the present disclosure will be described. The following embodiments are used to explain examples of the present disclosure. The present disclosure is not limited to the embodiments described below and also includes various types of modified embodiments to be performed without departing from the scope of the present disclosure. In addition, all compositions to be described below are not always required to be essential compositions of the present disclosure.

In this specification, “(meth)acryl” indicates acryl or methacryl, and “(meth)acrylate” indicates acrylate or methacrylate.

### 1. Ink Jet Ink Composition

An ink jet ink composition according to this embodiment is a water-based ink, the ink composition comprising: a colorant; a resin; a water-soluble low molecular weight organic compound A which is one of an amide, a sulfur-containing compound, and a cyclic ether and which satisfies the following condition (a) and condition (b); and a silicone-based surfactant which satisfies the following condition (c). In the ink jet ink composition described above, the condition (a) is that a surface tension of an aqueous solution at a concentration of 10 percent by mass is 42 to 56 mN/m, the condition (b) is that a standard boiling point is 150° C. to 300° C., and the condition (c) is that a solubility in water at 20° C. is 1 percent by mass or less.

Hereinafter, the ink jet ink composition according to this embodiment and components thereof will be described.

It has become to understand that when a solvent to dissolve a resin component in an ink jet ink composition is used, depending on the type of solvent, a sufficient abrasion resistance may not be obtained in some cases. In particular, when a surface tension of the solvent is low, the solvent is liable to permeate a recording medium, and the solvent which permeates the recording medium is estimated not to be able to sufficiently dissolve the resin component contained in the ink jet ink composition on the recording medium.

Furthermore, it has also become to understand that when a solvent having a high surface tension is used as the solvent to dissolve the resin component, color development of an image to be obtained becomes worse. The reason for this is estimated that since the solvent is not likely to wet-spread on the recording medium, the ink jet ink composition also insufficiently wet-spreads on the recording medium.

Accordingly, the ink jet ink composition of this embodiment is configured to contain the low molecular weight organic compound A described above and the specific silicone-based surfactant described above, and as a result, an ink jet ink composition capable of forming an image having preferable abrasion resistance and color development property is formed.

### 1.1. Colorant

The ink jet ink composition contains a colorant. The colorant may be either a pigment or a dye.

### Pigment

As the pigment, for example, an inorganic pigment, such as a carbon black or a titanium white, or an organic pigment may be used.

As the inorganic pigment, for example, a carbon black (C.I. Pigment Black 7), such as a furnace black, a lamp black, an acetylene black, or a channel black; an iron oxide, a titanium oxide, a zinc oxide, or a silica may be used.

As the carbon black, for example, there may be mentioned No. 2300, 900, MCF88, No. 20B, No. 33, No. 40, No. 45, No. 52, MA7, MA8, MA100, or No 2200B each manufactured by Mitsubishi chemical Co., Ltd.; or Color Black FW1, FW2, FW2V, FW18, FW200, S150, S160, or S170, Pretex 35, U, V, or 140U, or Special Black 6, 5, 4A, 4, or 250 each manufactured by Degussa AG. In addition, for example, Conductex SC, or Raben 1255, 5750, 5250, 5000, 3500, 1255, or 700 each manufactured by Columbia Carbon Inc. may also be mentioned. Regal 400R, 330R, or 660R, Mogul L, Monarch 700, 800, 880, 900, 1000, 1100, 1300, or 1400, or Elftex 12 each manufactured by Cabot Corporation may also be mentioned by way of example.

As the organic pigment, for example, there may be mentioned a quinacridone-based pigment, a quinacridonequinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, or an azo-based pigment.

As a concrete example of the organic pigment used in the ink jet ink composition, for example, the following may be mentioned.

As a cyan pigment, for example, C.I. Pigment Blue 1, 2, 3, 15:3, 15:4, 15:34, 16, 22, or 60; or C.I. Vat Blue 4 or 60 may be mentioned, and for example, one selected from the group consisting of C.I. Pigment Blue 15:3, 15:4, and 60 or a mixture containing at least two types thereof may be preferably mentioned.

As a magenta pigment, for example, C.I. Pigment Red 5, 7, 12, 48 (Ca), 48 (Mn), 57 (Ca), 57:1, 112, 122, 123, 168, 184, 202, or 209 or C.I. Pigment Violet 19 may be mentioned, and for example, one selected from the group consisting of C.I. Pigment Red 122, 202, and 209, and C.I. Pigment Violet 19 or a mixture containing at least two types thereof may be preferably mentioned.

As a yellow pigment, for example, C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, or 185 may be mentioned, and for example, one selected from the group consisting of C.I. Pigment Yellow 74, 109, 110, 128, 138, 155, and 180 or a mixture containing at least two types thereof may be preferably mentioned.

As an orange pigment, for example, C.I. Pigment Orange 36 or 43 or a mixture thereof may be mentioned. As a green pigment, for example, C.I. Pigment green 7 or 36 or a mixture thereof may be mentioned.

In addition, a bright pigment may also be used and is not particularly limited as long as having a bright property when being adhered to a medium, and for example, there may be mentioned metal particles (also called a metal pigment) of one selected from the group consisting of aluminum, silver, gold, platinum, nickel, chromium, tin, zinc, indium, titanium, copper, and an alloy containing at least two of those mentioned above or a pearl pigment having pearly glossiness. As a representative example of the pearl pigment, for example, a pigment, such as titanium dioxide-coated mica, argentine, or bismuth oxychloride, having pearly glossiness or interference glossiness may be mentioned. In addition, the bright pigment may be surface-treated in order to suppress a reaction with water.

In addition, a white pigment may also be used, and for example, a metal oxide or a metal compound, such as barium sulfate or calcium carbonate, may be mentioned. As the metal oxide, for example, titanium dioxide, zinc oxide, silica, alumina, or magnesium oxide may be mentioned. In addition, as the white pigment, particles each having a hollow structure may also be used.

The pigments mentioned above may be used alone, or at least two types thereof may be used in combination. The pigment is preferably an organic pigment in view of a storage stability, such as a light resistance, a weather resistance, and/or a gas resistance.

The pigment may be used after being dispersed using a pigment dispersant. In addition, the pigment may be dispersedly used as a self-dispersible pigment after a pigment surface is oxidized or sulfonated with, for example, ozone, hypochlorite, or fuming sulfuric acid.

The pigment dispersant has a function to disperse a pigment in an ink jet ink composition. Although the pigment dispersant may be water soluble, a pigment dispersant not having a perfect water solubility is preferable, and the reason for this is believed such that since the dispersant is partially or fully adsorbed or bonded to the pigment so as to enhance a hydrophilic property of the surface of the pigment, the pigment can be dispersed. The type of pigment dispersant is not particularly limited.

The pigment dispersant is a high molecular weight compound, and as an example thereof, an acrylic-based resin or its salt may be mentioned, and as the acrylic-based resin, for example, there may be mentioned a poly(meth)acrylic acid, a (meth)acrylic acid-acrylonitrile copolymer, a (meth)acrylic acid-(meth)acrylate copolymer, a vinyl acetate-(meth)acrylate copolymer, a vinyl acetate-(meth)acrylic acid copolymer, a vinyl naphthalene-(meth)acrylic acid copolymer, a styrene-(meth)acrylic acid copolymer, a styrene-(meth)acrylate copolymer, a styrene-(meth)acrylic acid-(meth)acrylate copolymer, a styrene-α-methylstyrene-(meth)acrylic acid copolymer, or a styrene-α-methylstyrene-(meth)acrylic acid-(meth)acrylate copolymer. In addition, in this specification, a polymer having a skeleton derived from (meth)acrylic acid and having no skeleton derived from maleic acid or its analogous compound is called the acrylic-based resin.

In addition, as the pigment dispersant, for example, there may be mentioned a resin including a maleic acid-based resin, such as a styrene-maleic acid copolymer, a styrene-maleic anhydride copolymer, a vinyl naphthalene-maleic acid copolymer, or a vinyl acetate-maleate copolymer, or its salt; a crosslinked or non-crosslinked urethane-based resin or its salt; a poly(vinyl alcohol); or a vinyl acetate-crotonic acid copolymer or its salt.

In addition, besides the polymers as described above each formed from an acrylic-based monomer, the acrylic-based resin may also be a copolymer formed from an acrylic-based monomer and another monomer. For example, an acrylic vinyl resin, that is, a copolymer using a vinyl-based monomer as the another monomer, is also called the acrylic-based resin. In addition, for example, among the styrene-based resins mentioned above, a copolymer between a styrene-based monomer and an acrylic-based monomer is also included in the acrylic-based resin. Furthermore, the acrylic-based resin also includes a salt and an ester compound thereof.

As a commercially available product of the pigment dispersant, for example, there may be mentioned X-200, X-1, X-205, X-220, or X-228 (manufactured by Seiko PMC Corporation); NOPCOSPERSE (registered trademark) 6100 or 6110 (manufactured by SAN NOPCO Limited); Joncryl 67, 586, 611, 678, 680, 682, or 819 (manufactured by BASF); DISPERBYK-190 (manufactured by BYK Japan KK); or N-EA137, N-EA157, N-EA167, N-EA177, N-EA197D, N-EA207D, or E-EN10 (manufactured by DKS Co., Ltd.).

As a commercially available product of an acrylic-based pigment dispersant, for example, there may be mentioned BYK-187, BYK-190, BYK-191, BYK-194N, or BYK-199 (manufactured by BYK Japan KK); or Aron A-210, A6114, AS-1100, AS-1800, A-30SL, A-7250, or CL-2 (manufactured by Toagosei Company, Limited).

As a commercially available product of an urethane-based pigment dispersant, for example, there may be mentioned BYK-182, BYK-183, BYK-184, or BYK-185 (manufactured by BYK Japan KK); TEGO Disperse 710 (manufactured by Evonic Tego Chemi); or Borchi (registered trademark) Gen 1350 (manufactured by OMG Borschers).

The pigment dispersant may be used alone, or at least two types thereof may be used in combination. A total content of the pigment dispersant with respect to 100 percent by mass of the ink is 0.1 to 30 percent by mass, preferably 0.5 to 25 percent by mass, more preferably 1 to 20 percent by mass, and further preferably 1.5 to 15 percent by mass. Since the content of the pigment dispersant is 0.1 percent by mass or more, a dispersion stability of the pigment can be secured. In addition, when the content of the pigment dispersant is 30 percent by mass or less, a viscosity of the ink jet ink composition can be decreased low.

In addition, the pigment dispersant more preferably has a weight average molecular weight of 500 or more. Since the pigment dispersant as described above is used, the odor is suppressed, and the dispersion stability of the pigment can be made more preferable.

When the pigment is dispersed by the pigment dispersant, a ratio of the pigment to the pigment dispersant is preferably 10:1 to 1:10 and more preferably 4:1 to 1:3.

In addition, a volume average particle diameter (D50) of the pigment measured by a dynamic light scattering method is preferably 20 to 300 nm, more preferably 30 to 200 nm, and further preferably 40 to 100 nm.

When the ink jet ink composition contains a pigment dispersed by a pigment dispersant, the pigment dispersant is preferably formed from an acrylic-based resin. Accordingly, the dispersibility of the pigment in the ink jet ink composition can be made more preferable.

### Dye

In the ink jet ink composition, as the colorant, a dye may also be used. The dye is not particularly limited, and for example, an acidic dye, a direct dye, a reactive dye, a basic dye, or a dispersive dye may be used. As the dye, for example, there may be mentioned C.I. Acid Yellow 17, 23, 42, 44, 79, or 142, C.I. Acid Red 52, 80, 82, 249, 254, or 289, C.I. Acid Blue 9, 45, or 249, C.I. Acid Black 1, 2, 24, or 94, C.I. Food Black 1 or 2, C.I. Direct Yellow 1, 12, 24, 33, 50, 55, 58, 86, 132, 142, 144, or 173, C.I. Direct Red 1, 4, 9, 80, 81, 132, 225, or 227, C.I. Direct Blue 1, 2, 15, 71, 86, 87, 98, 165, 199, or 202, C.I. Direct Black 19, 38, 51, 71, 154, 168, 171, or 195, C.I. Reactive Red 14, 32, 55, 79, 141, or 249, or C.I. Reactive Black 3, 4, or 35.

In addition, as the dye, a compound represented by the following formula (y-1) or its salt may be mentioned.

Those colorants including the pigments and the dyes may be used alone, or at least two types thereof may be used in combination.

A total content of the colorant with respect to a total mass (100 percent by mass) of the ink jet ink composition is preferably 0.10 to 20.0 percent by mass, more preferably 0.20 to 15.0 percent by mass, and further preferably 1.0 to 10.0 percent by mass. A clear composition (clear ink) containing no colorant or containing a small amount of the colorant (such as 0.1 percent by mass or less) so as not to perform coloration may also be formed.

### 1.2. Resin

The ink jet ink composition contains a resin. The resin is a high molecular weight compound and may be in the form of resin particles which form a dispersion state in the ink jet ink composition or may be in the form to be dissolved in the ink jet ink composition. The resin has a function to improve adhesion, abrasion resistance, and the like of an image formed by the ink jet ink composition adhered to a recording medium. The resin more preferably includes resin particles.

As the resin particles, for example, there may be mentioned an urethane-based resin, an acrylic-based resin (including a styrene-acrylic-based resin), a fluorene-based resin, a polyolefin-based resin, a rosin modified resin, a terpene-based resin, a polyester-based resin, a polyamide-based resin, an epoxy-based resin, a vinyl chloride-based resin, a vinyl chloride-vinyl acetate-based copolymer, or an ethylene-vinyl acetate-based resin, and among those mentioned above, an urethane-based resin, an acrylic-based resin, a polyolefin-based resin, or a polyester-based resin is preferable. Although being frequently used in the form of an emulsion, the resin particles may also be used in the form of a powder. In addition, the resin particles may be used alone, or at least two types thereof may be used in combination.

The urethane-based resin is a generic name of a resin having an urethane bond. As the urethane-based resin, for example, a polyether type urethane resin having an ether bond in its main chain besides the urethane bond, a polyester type urethane resin having an ester bond in its main chain besides the urethane bond, and a polycarbonate type urethane resin having a carbonate bond in its main chain besides the urethane bond may be used. In addition, as the urethane-based resin, a commercially available product may also be used, and for example, there may be used Superflex 460, 460s, or 840, or E-4000 (trade name, manufactured by DKS Co., Ltd.); Resamine D-1060, D-2020, D-4080, D-4200, D-6300, or D-6455 (trade name, manufactured by Dainichiseika Color & Chemicals Mfg. Co., Ltd.); Takelac WS-5100, WS-6021 or W-512-A-6 (trade name, manufactured by Mitsui Chemicals Polyurethanes Inc.); Suncure 2710 (trade name, manufactured by Lubrizol); or Permarin UA-150 (trade name, manufactured by Sanyo Chemical Industries, Ltd.).

The acrylic-based resin is a generic name of a polymer obtained by polymerization using at least one acrylic-based monomer, such as (meth)acrylic acid or a (meth)acrylate, as one component, and for example, a resin obtained from an acrylic-based monomer or a copolymer between an acrylic-based monomer and a monomer different therefrom may be mentioned. For example, an acrylic-vinyl-based resin which is a copolymer between an acrylic-based monomer and a vinyl-based monomer may be mentioned. In addition, for example, as a vinyl-based monomer, styrene may be mentioned.

As the acrylic-based monomer, for example, acrylamide or acrylonitrile may also be used. As a resin emulsion using an acrylic-based resin as a raw material, a commercially available product may be used, and at least one selected from the group consisting of FK-854 (trade name, manufactured by Chuo Rika Kogyo Corporation); Movinyl 952B and 718A (trade name, manufactured by Nippon Synthetic Chemical Industry Co., Ltd.); Nipol LX852 and LX874 (trade name, manufactured by Zeon Corporation), and the like may be used.

The styrene-acrylic-based resin is a copolymer obtained from a styrene monomer and a (meth)acrylic-based monomer, and for example, a styrene-acrylic acid copolymer, a styrene-methacrylic acid copolymer, a styrene-methacrylic acid-acrylate ester copolymer, a styrene-α-methylstyrene-acrylic acid copolymer, or a styrene-α-methylstyrene-acrylic acid-acrylate ester copolymer may be mentioned. As the styrene-acrylic-based resin, a commercially available product may also be used, and for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, manufactured by BASF); Movinyl 966A or 975N (trade name, manufactured by Nippon Synthetic Chemical Industry Co., Ltd.); or Vinyblan 2586 (trade name, manufactured by Nisshin Chemical Industry Co., Ltd.) may be mentioned.

The polyolefin-based resin is a resin having a structural skeleton of an olefin, such as ethylene, propylene, or butylene, and a known resin may be appropriately selected and used. As the olefin resin, a commercially available product may also be used, and for example, Arrowbase CB-1200 or CD-1200 (trade name, manufactured by Unitika Ltd.) may be used.

In addition, the resin particles may be supplied in the form of an emulsion, and as an example of a commercially available product of the resin emulsion as described above, there may be mentioned Microgel E-1002 or E-5002 (trade name, styrene-acrylic-based resin emulsion, manufactured by Nippon Paint Co., Ltd.); Boncoat 4001 (trade name, acrylic-based resin emulsion, manufactured by DIC Corporation); Boncoat 5454 (trade name, styrene-acrylic-based resin emulsion, manufactured by DIC Corporation); Polysol AM-710, AM-920, AM-2300, AP-4735, AT-860, or PSASE-4210E (acrylic-based resin emulsion), Polysol AP-7020 (styrene-acrylic resin emulsion), Polysol SH-502 (vinyl acetate resin emulsion), Polysol AD-13, AD-2, AD-10, AD-96, AD-17, or AD-70 (ethylene-vinyl acetate resin emulsion), or Polysol PSASE-6010 (ethylene-vinyl acetate resin emulsion) (trade name, manufactured by Showa Denko K.K.); Polysol SAE1014 (trade name, styrene-acrylic-based resin emulsion, manufactured by Zeon Corporation); Saivinol SK-200 (trade name, acrylic-based resin emulsion, manufactured by Saiden Chemical Industry Co., Ltd.); AE-120A (trade name, acrylic resin emulsion, manufactured by JSR Corporation); AE373D (trade name, carboxy-modified styrene-acrylic resin emulsion, manufactured by Emulsion Technology Co., Ltd.); Seikadyne 1900W (trade name, ethylene-vinyl acetate resin emulsion, manufactured by Dainichiseika Color & Chemicals Mfg. Co., Ltd.); Vinyblan 2682 (acrylic resin emulsion), Vinyblan 2886 (vinyl acetate-acrylic resin emulsion), or Vinylblan 5202 (acrylic acetate resin emulsion) (trade name, manufactured by Nisshin Chemical Industry Co., Ltd.); Elitel KA-5071S, KT-8803, KT-9204, KT-8701, KT-8904, or KT-0507 (trade name, polyester resin emulsion, manufactured by Unitika Ltd.); Hitech SN-2002 (trade name, polyester resin emulsion, manufactured by Toho Chemical Industry Co., Ltd.); Takelac W-6020, W-635, W-6061, W-605, W-635, or W-6021 (trade name, urethane-based resin emulsion, manufactured by Mitsui Chemicals & Polyurethanes Inc.); Superflex 870, 800, 150, 420, 460, 470, 610, or 700 (trade name, urethane-based resin emulsion, manufactured by DKS Co., Ltd.); Permarin UA-150 (urethane-based resin emulsion, manufactured by Sanyo Chemical Industries, Ltd.); Suncure 2710 (urethane-based resin emulsion, manufactured by Nippon Lubrizol); NeoRez R-9660, R-9637, or R-940 (urethane-based resin emulsion, manufactured by Kusumoto Chemicals, Ltd.); Adeka Bontigher HUX-380 or 290K (urethane-based resin emulsion, manufactured by ADEKA Corporation); Movinyl 966A or Movinyl 7320 (manufactured by Nippon Synthetic Chemical Industry Co., Ltd.); Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (manufactured by BASF); NK Binder R-5HN (manufactured by Shin-Nakamura Chemical Co., Ltd.); or Hydran WLS-210 (non-crosslinked polyurethane, manufactured by DIC Corporation).

When the resin includes resin particles, the resin particles are more preferably formed from one of an acrylic-based resin, a polyurethane-based resin, and a polyester-based resin. Accordingly, a clogging recovery property of nozzles of a recording head of an ink jet recording apparatus can be made more preferable, and in addition, an image having a more preferable abrasion resistance is likely to be obtained.

As a water-soluble resin is not particularly limited, and for example, a maleic acid-based resin may be mentioned. The maleic acid-based resin is a high molecular weight compound having a structure derived from a maleic acid.

As the maleic acid, for example, there may be mentioned a compound having a structure in which two carboxy groups are bonded to respective adjacent carbon atoms which are bonded to each other by an ethylenic carbon-carbon double bond or a compound which is derived therefrom.

As a concrete example of the maleic acid, for example, maleic acid, maleic anhydride, fumaric acid, citraconic acid, citraconic anhydride, or mesaconic acid may be mentioned. As the maleic acid, a compound in which the two carboxy groups bonded to the respective adjacent carbon atoms described above are cyclized with dehydration or esterified may also be used. A carboxy group forming a salt is also included in the carboxy group.

As the derivative described above, for example, a compound in which at least one of the carboxy groups is modified as described above or a compound in which the ethylene skeleton further has at least one substituent may also be mentioned.

Among the maleic acids, maleic acid or a maleic acid in which at least one of the carboxy groups is modified is preferable.

As the maleic acid-based resin, a resin in which the carboxy groups derived from a maleic acid are cyclized with dehydration or esterified may also be used. A carboxy group forming a salt is also included in the carboxy group.

The high molecular weight compound having a structure derived from a maleic acid can be a high molecular weight compound obtained by polymerization or copolymerization using at least a maleic acid.

The maleic acid-based resin may be a polymer formed from a maleic acid or a copolymer between a maleic acid and another monomer. As the another monomer in this case, for example, a vinyl monomer, such as styrene, vinyl naphthalene, or vinyl acetate, or an acrylic monomer, such as (meth)acrylic acid or a (meth)acrylate ester, may be mentioned.

The maleic acid-based resin has a structure derived from a maleic acid, that is, has a structure derived from two carboxy groups bonded to respective adjacent carbon atoms. In addition, for example, when acrylic acid is polymerized by a generally known method, a so-called head-to-tail polymerization occurs, and hence, the carboxy groups are rarely disposed at adjacent carbon atoms from a statistical point of view. Hence, in a polymer formed from an acrylic acid, compared to the case of a polymerization of a maleic acid, the carboxy groups are rarely disposed side by side on a main carbon chain of the polymer. Accordingly, for example, by a nuclear magnetic resonance (NMR) method or the like, whether or not adjacent carboxy groups are derived from a maleic acid can be confirmed.

The carboxy group of the maleic acid-based resin may be an esterified group. For example, the carboxy group described above may be esterified by a compound having a hydroxy group. The two carboxy groups of the structure derived from a maleic acid may be not esterified, one of them may be esterified, or both of them may be esterified.

In addition, when being not esterified, the carboxy groups of the structure derived from a maleic acid each may be present in the form of a carboxylic acid in a water-based ink jet ink composition or may be partially or fully neutralized with ammonia, an alkanolamine, or an alkylamine.

Since having many structures each derived from the carboxy groups of a maleic acid, the maleic acid-based resin is water soluble. Hence, in a water-based ink jet ink composition, molecular chains of the maleic acid-based resin have spreadability. Accordingly, when the ink jet ink composition and a treatment liquid are mixed together, the maleic acid-based resin and an aggregating agent contained therein come into contact with each other at a higher probability. Hence, the maleic acid-based resin has a preferable aggregation property, and as a result, an image quality of an image obtained by using the ink set can be improved.

When one of the two carboxy groups of the structure derived from a maleic acid of the maleic acid-based resin is esterified, a water resistance of an image to be obtained tends to be improved. In addition, when the two carboxy groups of the structure derived from a maleic acid are not esterified, the water resistance of an image to be obtained tends to be degraded. By the degree of esterification, since the balance between a hydrophilic property and a hydrophobic property of the maleic acid-based resin can be adjusted, a storage stability of the ink jet ink composition can be made more preferable, and in addition, the water resistance of an image to be obtained can be further improved. For example, a styrene-maleic anhydride half ester copolymer salt is preferable in terms of the balance between a hydrophilic property and a hydrophobic property. The reason for this is estimated that since the esterified carboxy group has a high hydrophobic property, insolubilization and/or solid-liquid separation during the reaction is promoted.

In addition, when the maleic acid-based resin includes a structure derived from maleic anhydride, the anhydride is considered to be transformed into at least one carboxy group in water by addition of water.

In addition, the maleic acid-based resin is a water-soluble resin and, unlike the pigment dispersant, is preferably present in the form of a solution so as to be dissolved in water used as a solvent component of the ink, for example, without adsorbing to the pigment or the like in the ink jet ink composition. Accordingly, a more excellent aggregation property can be obtained. When the ink contains a pigment dispersed by a pigment dispersant, the maleic acid-based resin described in this section is contained in the ink separately from the pigment dispersant.

Depending on the skeleton, the number of the functional groups, and the property of the resin forming the particles, the maleic acid-based resin shows an aggregation property by the function of an aggregating agent, such as calcium propionate, which will be described later.

The maleic acid-based resin preferably has an acidic group, such as a carboxy group, a sulfonate group, or a phosphate group. That is, even when the carboxy groups derived from a maleic acid are present in the form of an acid or a salt, or even when all the carboxy groups derived from a maleic acid are esterified, an acidic group, such as a carboxy group, a sulfonate group, or a phosphate group, is preferably present in the form of an acid or a salt on the skeleton or the ester group. In addition, the acid group may be partially or fully neutralized with ammonia, an alkanolamine, or an alkylamine.

A weight average molecular weight of the maleic acid-based resin is preferably 2,000 to 100,000, more preferably 5,000 to 60,000, and further preferably 10,000 to 50,000. When the weight average molecular weight described above is in the range described above, suppression of aggregation irregularity of an image to be obtained and improvement of the abrasion resistance thereof can be made more preferable. In addition, an ejection stability of the ink jet ink composition from an ink jet head is also preferable.

As a commercially available product of the maleic acid-based resin, for example, there may be mentioned SN Dispersant 5027 or 5029 (manufactured by San Nopco Limited); Sanspearl PS-8 (manufactured by Sanyo Chemical Industries, Ltd.); Malialim HKM-50A, 150A, AKM-0531, or SC-0505K, or Polyster OMA (manufactured by NOF Corporation); Demol P, EP, or ST, or Boise 520 or 521 (manufactured by Kao Corporation); Polity A550 (manufactured by Lion Corporation); Arastar 703S or Polymalon 1318, 351T, 385, 372, 375CB, 482, 482s, or 1329 (manufactured by Arakawa Chemical Industries, Ltd.); XIRAN 1440H, 2625H, 1000H, 2000H, or 3000H (manufactured by Polyscope); Isoban 104 (manufactured by Kuraray Co., Ltd.); or Florene G-700 AMP or G-700 DMEA (manufactured by Kyoeisha Chemical Co., Ltd.).

A content of the resin with respect to the total mass of the ink jet ink composition as a total solid content is 0.1 to 20 percent by mass, preferably 1 to 15 percent by mass, and more preferably 2 to 10 percent by mass.

### 1.3. Low Molecular Weight Organic Compound A

The ink jet ink composition contains a water-soluble low molecular weight organic compound A which is one of an amide, a sulfur-containing compound, and a cyclic ether and which satisfies the following condition (a) and condition (b).

Condition (a): a surface tension of an aqueous solution at a concentration of 10 percent by mass is 42 to 56 mN/m.

Condition (b): a standard boiling point is 150° C. to 300° C.

The low molecular weight organic compound A is a compound having a molecular weight of 500 or less. The molecular weight of the compound described above is preferably 400 or less, more preferably 300 or less, and further preferably 50 to 200.

The low molecular weight organic compound A is a water-soluble compound. The low molecular weight organic compound A has a solubility of more than 10 percent by mass in water at 20° C. For example, after the compound described above is mixed at a predetermined concentration with water at 20° C. and then stirred, when an undissolved compound is not observed, or the entire mixture liquid thus prepared is not observed to be cloudy by visual inspection, the compound is assumed to be dissolved in water. In the case in which the compound is dissolved in water, when the minimum concentration of the compound mixed with water is more than 10 percent by mass, the compound is regarded as a water-soluble compound. The “percent by mass” which indicates the solubility is a content represented by percent by mass of a low molecular weight organic compound with respect to a total mass of a mixture liquid obtained by mixing water and the low molecular weight organic compound.

The low molecular weight organic compound A has a surface tension of 42 to 56 mN/m (condition (a)) in the form of an aqueous solution at a concentration of 10 percent by mass and also has a standard boiling point of 150° C. to 300° C. (condition (b)).

As for the condition (a), although the surface tension of the aqueous solution at a concentration of 10 percent by mass is defined by the condition (a), the surface tension described above is preferably 45 to 55 mN/m, more preferably 46 to 54.5 mN/m, even more preferably 47 to 54.5 mN/m, and further preferably 50.0 to 54.5 mN/m. The surface tension may be measure by a known method at 20° C.

When the surface tension is a lower limit of the range described above or more, since the low molecular weight organic compound A can be suppressed from permeating a recording medium, and the resin can be sufficiently dissolved, the abrasion resistance is improved. When the surface tension is an upper limit of the range described above or less, the ink is likely to wet-spread on a recording medium and has an excellent color development property.

As for the condition (b), although being defined by the condition (b), the standard boiling point is preferably 160° C. to 290° C., more preferably 170° C. to 280° C., even more preferably 175° C. to 276° C., further preferably 200° C. to 270° C., and particularly preferably 230° C. to 270° C.

When the standard boiling point is 300° C. or less and preferably 280° C. or less, a drying property of the ink jet ink composition in a secondary heating step is made more preferable, and the abrasion resistance is also improved. On the other hand, when the standard boiling point is a lower limit of the range described above or more, on a recording medium, while the resin is not sufficiently dissolved, the low molecular weight organic compound A can be suppressed from being evaporated, and hence, the abrasion resistance is improved. The standard boiling point may be measured by a known method.

Concrete examples of the water-soluble low molecular weight organic compound A which satisfies the condition (a) and the condition (b) are shown in Table 1.

TABLE 1

| | | | BOILING | MIXTURE |
|---|---|---|---|---|
| | | | POINT | SURFACE |
| SOLVENT NAME | ABBREVIATION | TYPE | (° C.) | TENSION |
| ε-CAPROLACTAM | CPL | AMIDE | 267 | 54.08 |
| N-METHYL-ε-CAPROLACTAM | MCPL | AMIDE | 248 | 52.49 |
| N,N- | DMIB | AMIDE | 175 | 46.32 |
| DIMETHYLISOBUTYRAMIDE | | | | |
| SULFOLANE | SF | SULFUR- | 285 | 55.33 |
| | | CONTAINING | | |
| | | SOLVENT | | |
| 3-METHYLSULFOLANE | MSF | SULFUR- | 276 | 51.67 |
| | | CONTAINING | | |
| | | SOLVENT | | |
| 3-ETHYL-3- | EOXM | CYCLIC ETHER | 220 | 47.79 |
| OXETANEMETHANOL | | | | |
| SOLKETAL | SL | CYCLIC ETHER | 192 | 49.84 |

The ink jet ink composition may use only one type of the low molecular weight organic compound A or at least two types thereof.

Since the ink jet ink composition contains the low molecular weight organic compound A, the low molecular weight organic compound A is likely to function particularly as a solubilizing agent of a water-dispersible resin, and as a result, particles of the water-dispersible resin is likely to be swelled and/or softened. Accordingly, the flatness of the surface of an image to be formed is further improved, and the abrasion resistance of the image can be made more preferable.

As the amide, a water-soluble low molecular weight organic compound having an amide structure may be used. As the amide, for example, a cyclic amide or a non-cyclic amide may be mentioned.

As the sulfur-containing compound, a water-soluble low molecular weight organic compound having a sulfur atom in its molecule may be used. As the sulfur-containing compound, for example, a sulfone or a sulfoxide may be mentioned.

As the cyclic ether, a water-soluble low molecular weight organic compound having a cyclic ether structure may be used. For example, a compound having a four- to eight-membered ring cyclic ether structure may be mentioned. The number of oxygen atoms forming the ring is preferably 1 to 3. For example, an oxetane or a solketal may be mentioned.

As the low molecular weight organic compound A, when the amide is selected, a surface drying property and a fixing property of the ink jet ink composition adhered to a low-absorbing recording medium can be preferably further improved. In addition, the amide tends to have an excellent function to appropriately soften and/or dissolve a vinyl chloride-based resin. Hence, the amide softens and/or dissolves a recording surface of a recording medium containing a vinyl chloride-based resin so as to enable the ink jet ink composition to permeate the inside of the recording medium. Since the ink jet ink composition permeates the recording medium as described above, a component of the ink jet ink composition is tightly fixed, and in addition, the surface of the ink jet ink composition is more likely to be dried. Hence, an image to be obtained is likely to be more excellent in surface drying property and fixing property.

A content of the low molecular weight organic compound A in the ink jet ink composition with respect to the total mass of the ink jet ink composition is preferably 0.5 to 15 percent by mass, more preferably 1 to 10 percent by mass, even more preferably 2 to 9 percent by mass, further preferably 3 to 8 percent by mass, and particularly preferably 4 to 8 percent by mass. When the content described above is in the range described above, the flatness of the surface of an image to be formed is further improved, and an image having more preferable image quality and abrasion resistance can be formed.

The low molecular weight organic compound A has a function as a resin solubilizing compound, and when a compound having a surface tension of 42 mN/m or more is used, the low molecular weight organic compound A is not likely to permeate a recording medium and is able to sufficiently dissolve the resin on the recording medium, and as a result, the abrasion resistance of the image can be made excellent.

### 1.4. Silicone-Based Surfactant

The ink jet ink composition contains a silicone-based surfactant which satisfies the following condition (c).

Condition (c): the solubility in water at 20° C. is 1 percent by mass or less.

Since the ink jet ink composition contains the silicone-based surfactant which satisfies the condition (c), when the ink jet ink composition is adhered to a recording medium, the wet spreadability of the ink jet ink composition in a lateral direction (direction along an adhesion surface) can be made preferable, and an image having an excellent color development property can be formed. The silicone-based surfactant which satisfies the condition (c) is believed to have a relatively high hydrophobic property and to be likely to wet-spread on a low-absorbing recording medium or a non-absorbing recording medium.

Since the low molecular weight organic compound A described above has a surface tension of 42 mN/m or more in the form of an aqueous solution at a concentration of 10 percent by mass, compared to the case in which the surface tension of a low molecular weight organic compound in the form of an aqueous solution at a concentration of 10 percent by mass is less than that described above, the permeability to a recording medium is suppressed. In the case described above, by the low molecular weight organic compound A, the wet spreadability of the ink on a recording medium also tends to be suppressed, and the ink may not wet-spread. As a result, the color development property of the ink tends to be degraded in some cases.

Accordingly, since the silicone-based surfactant which satisfies the condition (c) is contained in the ink jet ink composition of this embodiment, even when the ink contains the low molecular weight organic compound A, the wet spreadability of the ink adhered to a recording medium can be made preferable, and hence, an image having an excellent color development property can be formed.

In addition, when the surface tension of a low molecular weight organic compound is more than 56 mN/m in the form of an aqueous solution at a concentration of 10 percent by mass, the wet spreadability of the ink on a recording medium is further suppressed, and even when the silicone-based surfactant which satisfies the condition (c) is contained in the ink, the color development property may be degraded in some cases.

Hence, when the ink contains the low molecular weight organic compound A and the silicone-based surfactant which satisfies the condition (c), the abrasion resistance and the color development property can be made excellent.

As for the condition (c), the solubility in water at 20° C. is more preferably 0.8 percent by mass or less, even more preferably 0.5 percent by mass or less, and further more preferably 0.2 percent by mass or less.

The solubility is obtained as described below. First, in order to determine whether or not the solubility is 1 percent by mass or less in an environment at 20° C., an aqueous solution at a concentration of 1 percent by mass (silicone-based surfactant:water=1 g: 99 g mixture solution) is formed and stirred, and when the solution is colorless and transparent, the surfactant is determined to be dissolved, and the solubility is assumed to be more than 1 percent by mass. When the solution is semi-transparent or opaque, or when an undissolved substance is observed, the surfactant is determined not to be dissolved, and the solubility is assumed to be 1 percent by mass or less.

Concrete examples of the silicone-based surfactant which satisfies the condition (c) are shown in Table 2.

TABLE 2

| PRODUCT NAME | SOLUBILITY | PRODUCER |
|---|---|---|
| BYK-349 | <0.1% | BYK JAPAN KK |
| BYK-3420 | 0.1-0.5% | BYK JAPAN KK |
| BYK-3450 | <0.1% | BYK JAPAN KK |
| BYK-3451 | <0.1% | BYK JAPAN KK |
| BYK-3456 | <0.1% | BYK JAPAN KK |
| BYK-3480 | <0.1% | BYK JAPAN KK |
| BYK-3481 | <0.1% | BYK JAPAN KK |
| BYK-3760 | <0.1% | BYK JAPAN KK |
| SAG002 | <0.1% | NISSHIN CHEMICAL INDUSTRY Co., Ltd. |
| SAG005 | <0.1% | NISSHIN CHEMICAL INDUSTRY Co., Ltd. |
| SAG016 | 0.1-0.5% | NISSHIN CHEMICAL INDUSTRY Co., Ltd. |
| SAG020 | <0.1% | NISSHIN CHEMICAL INDUSTRY Co., Ltd. |
| TEGO WET 240 | <0.1% | EVONIK JAPAN Co., Ltd. |
| TEGO TWIN 4000 | <0.1% | EVONIK JAPAN Co., Ltd. |
| TEGO TWIN 4100 | <0.1% | EVONIK JAPAN Co., Ltd. |
| TEGO TWIN 4200 | <0.1% | EVONIK JAPAN Co., Ltd. |
| DOWSIL 67 | <0.1% | DOW TORAY Co., Ltd. |
| DOWSIL 500W | <0.1% | DOW TORAY Co., Ltd. |
| DOWSIL 501W | <0.1% | DOW TORAY Co., Ltd. |

A content of the silicone-based surfactant with respect to the total mass of the ink jet ink composition is preferably 0.1 to 2 percent by mass, more preferably 0.2 to 1 percent by mass, and further preferably 0.3 to 0.8 percent by mass. When the content described above is in the range described above, the clogging recovery property of nozzles is made more preferable, and in addition, an image having a more preferable image quality can be obtained.

In the silicone-based surfactant, when the length of a Si chain and/or a polyoxyalkylene chain is adjusted in its molecular structure, the solubility in water can be adjusted. For example, when the length of the Si chain is increased, or the length of the polyoxyalkylene chain is decreased, the solubility in water can be decreased.

### 1.5. Other Components

### 1.5.1. Anionic Surfactant

The ink jet ink composition may contain an anionic surfactant represented by the following general formula (1).

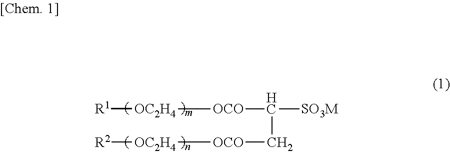

In the above general formula (1), R¹ and R² each independently represent a hydrogen atom or a linear or branched alkyl group having 1 to 20 carbon atoms, m and n each independently represent an integer of 0 to 20, and M represents an atom to be formed into a monovalent cation.

In addition, in the above general formula (1), —SO₃M may be ionized in the ink jet ink composition into —SO₃⁻ and M⁺.

Since the ink jet ink composition contains the anionic surfactant described above, by a synergetic effect with the silicone-based surfactant, the affinity to a recording medium is further enhanced, and as a result, an image having more preferable image quality and abrasion resistance can be obtained.

As a concrete example of the anionic surfactant, for example, there may be mentioned Disponil SUS IC 875 (manufactured by BASF Japan), Sanmorin OT-70 or Carabon DA-72 (manufactured by Sanyo Chemical Industries, Ltd.), Airroll CT-(manufactured by Toho Chemical Industry Co., Ltd.), Adekacol EC-8600 (manufactured by ADEKA Corporation), REWOPOL SB DO 75 PG (manufactured by Evonik Japan).

When the anionic surfactant is used, a content thereof with respect to the total mass of the ink jet ink composition is preferably 0.05 to 1 percent by mass, more preferably 0.1 to 0.8 percent by mass, and further preferably 0.1 to 0.5 percent by mass. When the content described above is in the range described above, the function described above can be easily obtained.

### 1.5.2. Water

The ink jet ink composition is a water-based ink containing water. A water-based composition indicates a composition containing water as one primary solvent component. The water may be contained as a primary solvent component and is a component to be evaporated by drying. The water is preferably pure water, such as ion exchange water, ultrafiltration water, reverse osmosis water, or distilled water, or water, such as ultrapure water, in which ionic impurities are removed as much as possible. In addition, in the case in which water sterilized by UV radiation, addition of hydrogen peroxide, or the like is used, generation of fungi and bacteria can be preferably suppressed when a treatment liquid or the ink jet ink composition is stored for a long time. A content of the water with respect to the total mass of the ink jet ink composition is preferably 40 percent by mass or more, more preferably 45 percent by mass or more, even more preferably 50 to 98 percent by mass, and further preferably 55 to 95 percent by mass.

### 1.5.3.1. Other Low Molecular Weight Organic Compounds

The ink jet ink composition may also contain a water-soluble low molecular weight organic compound which is one of an amide, a sulfur-containing compound, and a cyclic ether and which satisfies the above condition (b).

That is, besides the low molecular weight organic compound A, a water-soluble low molecular weight organic compound which is one of an amide, a sulfur-containing compound, and a cyclic ether and which satisfies the above condition (b) but does not satisfy the condition (a) may also be contained. The compound described above is called the other low molecular weight organic compound.

In the ink jet ink composition described above, when a total mass of the water-soluble low molecular weight organic compound which is one of an amide, a sulfur-containing compound, and a cyclic ether and which satisfies the above condition (b) is assumed to be 100 percent by mass, a content of the low molecular weight organic compound A described above (which satisfies the condition (a) and the condition (b)) is preferably set to 50 percent by mass or more.

That is, in the case in which the ink jet ink composition contains, besides the low molecular weight organic compound A described above, the compound (the other low molecular weight organic compound), that is, the water-soluble low molecular weight organic compound which is one of an amide, a sulfur-containing compound, and a cyclic ether and which satisfies the condition (b) but does not satisfy the condition (a), a total mass including the other low molecular weight organic compound is assumed to be 100 percent by mass, a lower limit of the content of the low molecular weight organic compound A is preferably 50 percent by mass or more, more preferably 60 percent by mass or more, even more preferably 70 percent by mass or more, and further preferably 80 percent by mass or more. An upper limit of the content described above is 100 percent by mass or less. That is, the other low molecular weight organic compound may not be contained.

That is, when a total mass of the water-soluble low molecular weight organic compounds each of which is one of an amide, a sulfur-containing compound, and a cyclic ether and each of which has a standard boiling point of 150° C. to 300° C. is assumed to be 100 percent by mass, a mass ratio of the water-soluble low molecular weight organic compound which has a surface tension of 42 to 56 mN/m in the form of an aqueous solution at a concentration of 10 percent by mass is preferably in the range described above.

Accordingly, an effect of the low molecular weight organic compound A can be sufficiently obtained, and the clogging recovery property of nozzles can be made more preferable, and an image having more preferable image quality and abrasion resistance can be obtained.

As the other low molecular weight organic compound, although an amide, a sulfur-containing compound, or a cyclic ether may be mentioned among the organic solvents which will be described below, a compound in the form of a solid at ordinary temperature may also be mentioned.

### 1.5.3.2. Organic Solvent

The ink jet ink composition may contain an organic solvent. The organic solvent is a low molecular weight organic compound in the form of a liquid at ordinary temperature. Among the water-soluble low molecular weight organic compound A and the other low molecular weight organic compound described above, a liquid compound at ordinary temperature may also be able to function as an organic solvent.

The organic solvent may be a water-soluble low molecular weight organic compound or a solvent other than a water-soluble low molecular weight organic compound. The organic solvent is preferably a water-soluble organic solvent. As the function of the organic solvent, for example, there may be mentioned a function to improve a wettability of the ink jet ink composition to a recording medium and a function to enhance a moisture retaining property of the ink jet ink composition. In addition, the organic solvent may also function as a penetrant.

As the organic solvent, for example, an amide, a sulfur-containing compound, a cyclic ether, an alkylene glycol ether, a cyclic ester, an ester, or a polyvalent alcohol may be mentioned. Among those mentioned above, for example, an alkylene glycol ether or a polyvalent alcohol is preferable.

As the amide, for example, a cyclic amide or a non-cyclic amide may be mentioned. As the non-cyclic amide, for example, an alkoxyalkylamide may be mentioned. When the ink jet ink composition contains an amide, the abrasion resistance of an image and wet spreadability on a recording medium can be made further preferable. The organic solvent preferably includes an amide, and in particular, a non-cyclic amide is preferable.

As the cyclic amide, a lactam may be mentioned, and for example, there may be mentioned a pyrrolidone, such as 2-pyrrolidone, 1-methyl-2-pyrrolidone, 1-ethyl-2-pyrrolidone, 1-propyl-2-pyrrolidone, or 1-butyl-2-pyrrolidone; 2-piperidone, ε-caprolactam, N-methyl-ε-caprolactam, N-cyclohexyl-2-pyrrolidone, 5-methyl-2-pyrrolidone, β-propiolactam, ω-heptalactam, or succinimide. Those compounds mentioned above are preferable in terms of solubility of an aggregating agent and promotion of film formation of resin particles which will be described later, and in particular, 2-pyrrolidone or ε-caprolactam is more preferable.

As the non-cyclic amide, for example, an alkylamide may be mentioned, and for example, an alkoxyalkylamide may be mentioned. In addition, as the alkylamide other than the alkoxyalkylamide, for example, an alkylamide having a structure in which an alkoxy group is excluded from an alkoxyalkylamide may be mentioned.

As the non-cyclic amide, for example, there may be mentioned an alkoxyalkylamide, such as 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, or 3-tert-butoxy-N,N-methylethylpropionamide; N,N-dimethylacetoacetamide, N,N-diethylacetoacetamide, N-methylacetoacetamide, N,N-dimethylisobutyramide, N,N-dimethylformamide, N,N-diethylformamide, N,N-dimethylacetamide, N,N-diethylacetamide, or N,N-dimethylpropionamide.

In addition, as the alkoxyalkylamide, a compound represented by the following general formula (2) is preferably also used.

R¹—O—CH₂CH₂—(C═O)—NR²R³ (2)

In the above formula (2), R¹ represents an alkyl group having 1 to 4 carbon atoms, and R² and R³ each independently represent a methyl group or an ethyl group. The “alkyl group having 1 to 4 carbon atoms” may be a linear or branched alkyl group and may be a methyl group, an ethyl group, an n-propyl group, an iso-propyl group, an n-butyl group, a sec-butyl group, an iso-butyl group, or a tert-butyl group. The compound represented by the above formula (2) may be used alone, or at least two types thereof may be used in combination.

As a function of the compound represented by the formula (2), for example, improvement in surface drying property and fixing property of the ink jet ink composition adhered to a low-absorbing recording medium may be mentioned. In particular, the compound represented by the above formula (2) has an excellent function to appropriately soften and/or dissolve a vinyl chloride-based resin. Hence, the compound represented by the above formula (2) is able to soften and/or dissolve a recording surface containing a vinyl chloride-based resin and enables the ink jet ink composition to permeate the inside of the low-absorbing recording medium. Since the ink jet ink composition permeates the low-absorbing recording medium as described above, the ink jet ink composition is tightly fixed, and in addition, the surface of the ink jet ink composition is more likely to be dried. Hence, an image to be obtained is likely to have excellent surface drying property and fixing property.

In addition, in the above formula (2), R¹ more preferably represents a methyl group having one carbon atom. In the above formula (2), a standard boiling point of a compound in which R¹ represents a methyl group is low as compared to a standard boiling point of a compound in which R¹ represents an alkyl group having 2 to 4 carbon atoms. Hence, when a compound in which R¹ represents a methyl group in the above formula (2) is used, a surface drying property (in particular, a surface drying property of an image recorded in a high-temperature and high-humidity environment) in a adhesion region may be further improved in some cases.

When the amide is used, although a content of the amide with respect to the total mass of the ink jet ink composition is not particularly limited, the content described above is approximately 2 to 50 percent by mass and is preferably 4 to 30 percent by mass. When the content is in the range described above, the fixing property and the surface drying property (in particular, a surface drying property of an image recorded in a high-temperature and high-humidity environment) of the image may be further improved in some cases.

As the sulfur-containing compound, for example, a sulfoxide or a sulfone may be mentioned.

As the sulfoxide, for example, there may be mentioned a non-cyclic sulfoxide, such as dimethyl sulfoxide or diethyl sulfoxide; or a cyclic sulfoxide such as tetramethyl sulfoxide. As the sulfone, for example, there may be mentioned a cyclic sulfone, such as 3-methylsulfolane or sulfolane; or a non-cyclic sulfone, such as ethyl isopropyl sulfone, ethyl methyl sulfone, or dimethyl sulfone.

As the cyclic ether, for example, there may be mentioned tetrahydrofuran, 1,4-dioxane, dimethyl isosorbide, 3-methyl-3-oxetanemethanol, 3-ethyl-3-oxetanemethanol, 2-hydroxymethyloxetane, tetrahydrofurfuryl alcohol, glycerol formal, solketal, 1,4-dioxane-2,3-diol, or dihydrolevoglucosenone.

As the alkylene glycol ether, a monoether or a diether of an alkylene glycol may be used, and an alkyl ether is preferable. As a particular example, for example, there may be mentioned an alkylene glycol monoalkyl ether, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, or tripropylene glycol monobutyl ether; or an alkylene glycol dialkyl ether, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, or tripropylene glycol dimethyl ether. In the alkylene glycol ether, the number of carbon atoms of an alkylene glycol portion is preferably 2 to 6, and the number of carbon atoms of an ether portion is preferably 1 to 4.

In addition, since the resin in the ink jet ink composition is likely to be dissolved and/or swelled, and the abrasion resistance of an image to be formed tends to be improved, a diether of the alkylene glycol ether is more preferable as compared to a monoether thereof. On the other hand, the monoether is preferable since the wettability of the ink jet ink composition is further improved in some cases.

As the cyclic ester, for example, there may be mentioned a cyclic ester (lactone), such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, ε-decanolactone, or a compound in which a hydrogen atom of a methylene group adjacent to a carbonyl group of one of the esters mentioned above is substituted by an alkyl group having 1 to 4 carbon atoms.

As the ester, for example, there may be mentioned a glycol monoacetate, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, or methoxybutyl acetate; or a glycol diester, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, or dipropylene glycol acetate propionate.

The polyvalent alcohol is a compound having at least two hydroxy groups in its molecule. As the polyvalent alcohol, for example, an alkane polyol in which hydrogen atoms of an alkane are substituted by at least two hydroxy groups or a condensate of at least two molecules of the alkanepolyol obtained by intermolecular condensation between hydroxy groups may be mentioned. As the polyvalent alcohol, the number of carbon atoms is preferably 2 to 10.

As the polyvalent alcohol, for example, there may be mentioned a 1,2-alkanediol, such as ethylene glycol, propylene glycol (alias: 1,2-propanediol), 1,2-butanediol, 1,2-pentanediol, 1,2-hexanediol, 1,2-heptanediol, or 1,2-octanediol; diethylene glycol, dipropylene glycol, 1,3-propanediol, 1,3-butanediol (alias: 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, or glycerin. The polyvalent alcohols may be used alone, or at least two types thereof may be used in combination.

The polyvalent alcohol is able to primarily function as a penetrant and/or a moisturizing agent. In particular, a 1,2-alkanediol having at least 5 carbon atoms strongly tends to function as a penetrant.

When the ink jet ink composition contains an organic solvent, the organic solvent may be used alone, or at least two types thereof may be used in combination. In addition, a content of the organic solvent with respect to the total mass of the ink jet ink composition is for example, 5 to 50 percent by mass, preferably 5 to 30 percent by mass, more preferably 10 to 25 percent by mass, and further preferably 15 to 25 percent by mass. Since the content of the organic solvent is in the range described above, the clogging recovery property of nozzles is made more preferable, and in addition, an image having a more preferable drying property can be obtained.

In addition, when the ink jet ink composition contains an organic solvent, among the organic solvents described above by way of example, an organic solvent having a standard boiling point of 160.0° C. to 280.0° C. is more preferably contained. Accordingly, an image to be formed can be recorded by more rapid drying and fixing thereof. In addition, the abrasion resistance of the image, the wet spreadability on a recording medium, and/or the drying property of the image can be made more preferable.

Furthermore, the ink jet ink composition is more preferably configured not to contain more than 1.0 percent by mass of an organic solvent which is a polyvalent alcohol having a standard boiling point of more than 280.0° C. In the ink jet ink composition, a content of the organic solvent which is a polyvalent alcohol having a standard boiling point of more than 280.0° C. with respect to the total mass of the ink jet ink composition is preferably 5 percent by mass or less, more preferably 3 percent by mass or less, even more preferably 1 percent by mass or less, further preferably 0.5 percent by mass or less, and particularly preferably 0.1 percent by mass or less. A lower limit of the content of the organic solvent which is a polyvalent alcohol having a standard boiling point of more than 280.0° C. may be 0 percent by mass. The case in which the content is not more than x percent by mass indicates that the content is x percent by mass or less, that is, indicates that the content is between 0 to x percent by mass. In addition, the ink jet ink composition may contain if needed, a polyvalent alcohol, such as trimethylolpropane or glycerin, having a standard boiling point of 280° C. or more.

Accordingly, the drying of an image to be formed is made preferable, a more rapid recording can be performed, and the adhesion to a recording medium can also be improved. Furthermore, in the ink jet ink composition, the content of an organic solvent (not limited to the polyvalent alcohol) having a standard boiling point of more than 280.0° C. is more preferably set in the range described above. As the organic solvent having a standard boiling point or more than 280° C., for example, glycerin or a polyethylene glycol monomethyl ether may be mentioned.

In addition, among the organic solvents described above, the ink jet ink composition is more preferably configured not to contain more than 9 percent by mass of an organic solvent having a surface tension of 35 mN/m or less in the form of an aqueous solution at a concentration of 10 percent by mass. Accordingly, an image having more preferable color development property can be formed.

### 1.5.4. Surfactant

The ink jet ink composition may also contain a surfactant other than the silicone-based surfactant and the anionic surfactant described above. The surfactant has a function to decrease the surface tension of the ink jet ink composition and to improve the wettability thereof to a recording medium and/or an under layer. Among the surfactants, a surfactant selected from an acetylene glycol-based surfactant, a silicone-based surfactant which does not satisfy the above condition (c), or a fluorine-based surfactant is preferably used.

Although the acetylene glycol-based surfactant is not particularly limited, for example, there may be mentioned Surfyol 104, 104E, 104H, 104A, 104BC, 104 DPM, 104PA, 104PG-50, 104S, 420, 440, 465, 485, SE, SE-F, 504, 61, DF37, DF-110D, CT111, CT121, CT131, CT136, TG, or GA (trade name, manufactured by Air Products & Chemicals Inc.); Olfine B, Y, P, A, STG, SPC, E1004, E1010, PD-001, PD-002W, PD-003, PD-004, EXP.4001, EXP.4036, EXP.4051, AF-103, AF-104, AK-02, SK-14, or AE-3 (trade name, manufactured by Nisshin Chemical Industry Co., Ltd.); or Acetylenol E00, E00P, E40, or E100 (trade name, manufactured by Kawaken Fine Chemicals Co., Ltd.).

Although the silicone-based surfactant which does not satisfy the condition (c) is not particularly limited, a polysiloxane-based compound is preferably mentioned. Although the polysiloxane-based compound is not particularly limited, for example, a polyether modified organosiloxane may be mentioned. As a commercially available product of the polyether modified organosiloxane, for example, there may be mentioned BYK-306, BYK-307, BYK-3331, BYK-333, BYK-341, BYK-345, BYK-346, BYK-348, BYK-349, BYK-3420, BYK-3480, or BYK-3481 (trade name, manufactured by BYK Japan KK); or KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.); SAG003, SAG502, SAG503A, or SAG008 (trade name, manufactured by Nisshin Chemical Industry Co., Ltd.); TEGO WET 260, TEGO WET 280, or TEGO WET KL245 (trade name, manufactured by Evonik Japan); or DOWSIL 502W (trade name, manufactured by Dow Toray Co., Ltd.).

As the fluorine-based surfactant, for example, a fluorine modified polymer is preferably used, and as a concrete example, BYK-3440 (trade name, manufactured by BYK Japan KK); Surflon S-241, S-242, or S-243 (trade name, manufactured by AGC Seimi Chemical Co., Ltd.); or Ftergent 215M (trade name, manufactured by Neos Co., Ltd.) may be mentioned.

When the surfactant is contained in the ink jet ink composition, at least two types of surfactants may be contained. A content of the surfactant contained in the ink jet ink composition with respect to the total mass thereof is preferably 0.1 to 2.0 percent by mass, more preferably 0.2 to 1.5 percent by mass, and even more preferably 0.3 to 1.0 percent by mass.

### 1.5.5. Additives

The ink jet ink composition may contain as additives, an urea, an amine, a saccharide, and/or the like. As the urea, for example, urea, ethyleneurea, tetramethylurea, thiourea, or 1,3-dimethyl-2-imidazolidinone may be mentioned, and a betaine (such as trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, or acetylcarnitine) may also be mentioned.

As the amine, for example, there may be mentioned an alkanolamine, such as monoethanolamine, diethanolamine, triethanolamine, N,N-dimethylethanolamine, N,N-diethylethanolamine, N,N-dibutylethanolamine, N-aminoethylethanolamine, N-methylethanolamine, N-ethylethanolamine, N-butylethanolamine, N-tert-butylethanolamine, N-methyldiethanolamine, N-ethyldiethanolamine, N-butyldiethanolamine, N-tert-butyldiethanolamine, 2-amino-1-propanol, 2-amino-2-methyl-1-propanol, 5-amino-1-pentanol, 2-amino-2-methyl-1,3-propanediol, 2-amino-2-hydroxymethyl-1,3-propanediol, 3-amino-1,2-propanediol, 3-methylamino-1,2-propanediol, propanolamine, N,N-dimethylpropanolamine, N,N-diethylpropanolamine, tripropanolamine, isopropanolamine, diisopropanolamine, triisopropanolamine, N,N-dimethylisopropanolamine, or N,N-diethylisopropanolamine. The urea or the amine may be used to function as a pH adjuster.

As the saccharoid, for example, there may be mentioned glucose, mannose, fructose, ribose, xylose, arabinose, galactose, aldonic acid, glucitol (sorbit), maltose, cellobiose, lactose, sucrose, trehalose, or maltotriose.

### 1.5.6. Others

The ink jet ink composition may further contain if needed components, such as an antiseptic agent/fungicide, a rust inhibitor, a chelating agent, a viscosity adjuster, an antioxidant, and/or an antifungal agent.

### 1.6. Production and Physical Properties of Ink Jet Ink Composition

A viscosity of the ink jet ink composition at 20° C. is preferably 2 to 15 mPas. When the viscosity of the ink jet ink composition at 20° C. is in the range described above, an ink jet method is more preferably performed, the ink jet ink composition is more appropriately ejected from a nozzle, and flight bending and scattering of the ink jet ink composition can be further suppressed; hence, an ink jet recording apparatus can be more preferably used.

The ink jet ink composition can be obtained such that the components described above are mixed together in an appropriate order, and if needed, impurities are removed by filtration or the like. As a mixing method of the components, a method in which the materials are added in a container equipped with a stirring device, such as a mechanical stirrer or a magnetic stirrer, and are then stirred and mixed together is preferably used.

### 1.7. Application of Ink Jet Ink Composition

The ink jet ink composition of this embodiment is more preferably used for recording on a low-absorbing recording medium or a non-absorbing recording medium. Even when a low-absorbing recording medium or a non-absorbing recording medium is used, the ink jet ink composition is able to obtain an image having preferable image quality and abrasion resistance.

### 1.8. Operational Effect

According to the ink jet ink composition of this embodiment, since the low molecular weight organic compound A satisfies the condition (a) and the condition (b), the clogging recovery property of nozzles is made preferable, and in addition, an image having preferable image quality and abrasion resistance can be obtained.

That is, when the surface tension of the low molecular weight organic compound A is low so as not to satisfy the condition (a), although the wet spreadability on a recording medium is obtained, the permeability in a thickness direction of the recording medium is also enhanced at the same time; hence, in the ink jet ink composition of this embodiment, the surface tension is adjusted to satisfy the condition (a) so as to suppress the permeability. The ink jet ink composition contains the silicone-based surfactant which satisfies the condition (c) so as to compensate for the wet spreadability on the recording medium.

On the other hand, in the ink jet ink composition of this embodiment, when the surface tension of the low molecular weight organic compound A is high so as not to satisfy the condition (a), even if the silicone-based surfactant which satisfies the condition (c) is used, the wet spreadability on a recording medium is insufficient, and hence, the condition (a) is limited by an upper limit. That is, in the ink jet ink composition of this embodiment, as the low molecular weight organic compound A, since a compound having a surface tension in a predetermined range which is not excessively high or low is used, and the specific silicone-based surfactant described above is used together therewith, an excellent color development and abrasion resistance are obtained at the same time.

### 2. Recording Method

A recording method according to this embodiment includes an ink adhesion step of adhering the ink jet ink composition described above to a recording medium by an ink jet method.

### 2.1. Recording Medium

A recording medium to form an image by the recording method according to this embodiment may have a recording surface which absorbs a liquid such as an ink jet ink composition or may have no recording surface which absorbs a liquid. Hence, the recording medium is not particularly limited, and for example, a liquid absorbing recording medium, such as paper or a cloth, a liquid low-absorbing recording medium, such as printing paper, or a liquid non-absorbing recording medium, such as a metal, a glass, a film, or a high molecular weight material, may be mentioned. However, an excellent effect of the recording method according to this embodiment becomes more significant when an image is recorded on a liquid low-absorbing medium or a liquid non-absorbing recording medium. That is, according to the recording method of this embodiment, even by a low-absorbing recording medium or a non-absorbing recording medium which is relatively liable to generate aggregation irregularity, an image having a high image quality and a preferable abrasion resistance can be formed.

The liquid low-absorbing recording medium and the liquid non-absorbing recording medium indicate a recording medium hardly absorbing a liquid and a recording medium absorbing no liquid, respectively. From a quantitative point of view, the liquid non-absorbing recording medium or the liquid low-absorbing recording medium indicates a “recording medium having a water absorbing amount of 10 mL/m² or less from a contact start to a point of 30 msec^{1/2} by Bristow method”. This Bristow method is a most popular measurement method of a liquid absorption amount in a short time and has also been employed by Japan Technical Association of the Pulp and Paper Industry (JAPAN TAPPI). The details of the test method have been disclosed in Standard No. 51 “Paper and Paperboard-Liquid Absorption Test Method-Bristow Method”, JAPAN TAPPI PAPER AND PULP TEST METHODS, 2000. On the other hand, the liquid absorbing recording medium indicates a recording medium not corresponding to the liquid non-absorbing recording medium or the liquid low-absorbing recording medium. In addition, in this specification, the liquid low-absorbing recording medium and the liquid non-absorbing recording medium are simply called a low-absorbing recording medium and a non-absorbing recording medium, respectively, in some cases.

As the liquid non-absorbing recording medium, for example, there may be mentioned a film or a plate of a plastic, such as a poly(vinyl chloride), a polyethylene, a polypropylene, or a poly(ethylene terephthalate) (PET); a plate of a metal, such as iron, silver, copper, or aluminum; a metal plate or a plastic film formed by deposition of at least one of the above various metals; or a plate of an alloy, such as stainless steel or brass. In addition, for example, as the recording medium described above, a medium in which a plastic is coated on a substrate such as paper, a medium in which a plastic film is adhered to a substrate such as paper, or a plastic film having no absorbing layer (receiving layer) may also be mentioned. As the plastic described above, for example, there may be mentioned a poly(vinyl chloride), a poly(ethylene terephthalate), a polycarbonate, a polystyrene, a polyurethane, a polyethylene, or a polypropylene.

In addition, as the liquid low-absorbing recording medium, a recording medium having a surface on which a coating layer (receiving layer) to receive a liquid is provided may be mentioned. For example, as a recording medium using paper as a substrate, printing paper may be mentioned, and as a recording medium using a plastic film as a substrate, a recording medium in which, for example, a hydrophilic polymer is applied on a surface formed, for example, from a poly(vinyl chloride), a poly(ethylene terephthalate), a polycarbonate, a polystyrene, a polyurethane, a polyethylene, or a polypropylene or a recording medium in which particles formed of silica, titanium, or the like are applied together with a binder on the surface as described above may be mentioned.

Although the liquid absorbing recording medium is not particularly limited, for example, there may be mentioned regular paper, such as electrophotographic paper, having a high liquid permeability; ink jet paper (ink jet exclusive paper having an ink absorbing layer formed from silica particles or aluminum particles or having an ink absorbing layer formed from a hydrophilic polymer, such as a poly(vinyl alcohol) (PVA) or a poly(vinyl pyrrolidone) (PVP)); or art paper, coated paper, or cast paper, which has a relatively low liquid permeability and which is used for general offset printing. Furthermore, as the liquid absorbing recording medium, for example, a cloth or a non-woven cloth may also be mentioned.

In addition, the recording medium may be, for example, any one of a colorless transparent, a translucent, a colored transparent, a colored opaque, and an achromatic opaque medium. In addition, the recording medium itself may be either colored, translucent, or transparent.

### 2.2. Ink Adhesion Step

The ink adhesion step may be performed by any method as long as the ink jet ink composition is adhered while a recording head and a recording medium are relatively scanned. For example, the ink adhesion step is preferably performed by an ink jet method in which the recording head is used as an ink jet head, and the ink jet ink composition is ejected from the ink jet head. Accordingly, by a small apparatus, low-volume high-mix printing can be efficiently performed. Besides the ink jet method, the adhesion of the ink may be performed by an analogue printing method or the like.

The ink adhesion step can be easily performed by an ink jet recording apparatus. The details of the ink jet recording apparatus will be described later. A composition to be ejected from an ink jet head by an ink jet method and to be used for recording is called an ink jet ink composition.

According to the recording method of this embodiment, since the ink jet ink composition described above is used, an image having preferable image quality and abrasion resistance can be obtained.

The ink adhesion step may be performed at a surface temperature of the recording medium of 50° C. or less. That is, the ink adhesion step may be performed with or without heating of the recording medium, and when heating is performed, the heating is performed so that the recording medium has a surface temperature of 50° C. or less. Accordingly, an image having preferable image quality and abrasion resistance can be obtained with a preferable drying property. In addition, if needed, the ink adhesion step may also be performed by cooling.

### 2.3. Other Steps

The recording method may also include a treatment liquid adhesion step, a heating step, a laminating step, and the like.

### 2.3.1. Treatment Liquid Adhesion Step

The treatment liquid adhesion step is a step to adhere a treatment liquid to the recording medium. As a method to adhere the treatment liquid to the recording medium, one of a non-contact method and a contact method, such as an ink jet method, a coating method, a method of applying the treatment liquid to the recording medium by using various types of sprays, a method of applying the treatment liquid by immersing the recording medium therein, and a method of applying the treatment liquid to the recording medium by using a brush or the like, may be used, or at least two of the methods described above may be used in combination.

The treatment liquid adhesion step may be performed by an ink jet recording apparatus. Accordingly, by one ink jet recording apparatus, the treatment liquid and the ink jet ink composition can be preferably adhered to the recording medium. The treatment liquid will be described below, and the details of the ink jet recording apparatus will be described later.

### Treatment Liquid

The treatment liquid contains an aggregating agent. Hereinafter, components to be contained in the treatment liquid will be described.

### Aggregating Agent

The treatment liquid contains an aggregating agent to aggregate the components contained in the ink jet ink composition. The ink jet ink composition described above is excellent in aggregation property of the resin and/or the colorant by the aggregating agent of the treatment liquid, and hence, an image having an excellent image quality can be obtained.

Since working on the dispersibility of the components, such as the resin, the pigment, and a water-dispersible resin, contained in the ink jet ink composition, the aggregating agent has a function to aggregate at least one of dispersions thereof. The degree of the aggregation of the dispersion by the aggregating agent is changed depending on the types of aggregating agent and an object to be aggregated and can be adjusted. By the aggregation function as described above, for example, the color development property and/or the fixing property of an image can be enhanced.

Although the aggregating agent is not particularly limited, for example, a metal salt, an acid, or a cationic compound may be mentioned, and as the cationic compound, for example, a cationic resin (cationic polymer) or a cationic surfactant may be used. Among those mentioned above, as the metal salt, a polyvalent metal salt is preferable, and as the cationic compound, a cationic resin is preferable. As the acid, an organic acid or an inorganic acid may be mentioned, and an organic acid is preferable. Accordingly, when the aggregating agent is selected from a cationic resin, an organic acid, and a polyvalent metal salt, an image particularly excellent in image quality, abrasion resistance, glossiness, and the like can be preferably obtained.

Although the polyvalent metal salt is preferable as the metal salt, a metal salt other than the polyvalent metal salt may also be used. Among those aggregating agents, since having an excellent reactivity with the components contained in the ink, at least one selected from a metal salt and an organic acid is preferably used. In addition, among the cationic compounds, since being likely to be dissolved in the treatment liquid, a cationic resin is preferably used. In addition, at least two types of aggregating agents may also be used in combination.

The polyvalent metal salt is a compound formed from at least divalent metal ion and an anion. As the at least divalent metal ion, for example, an ion of calcium, magnesium, copper, nickel, zinc, barium, aluminum, titanium, strontium, chromium, cobalt, iron, or the like may be mentioned. Among the metal ions forming those polyvalent metal salts, since being excellent in aggregation property of the components of the ink, at least one of a calcium ion and a magnesium ion is preferable.

As the anion forming the polyvalent metal salt, an inorganic ion or an organic ion may be mentioned. That is, the polyvalent metal salt of the present disclosure is a salt formed from a polyvalent metal and an inorganic ion or an organic ion. As the inorganic ion as described above, for example, a chlorine ion, a bromine ion, an iodine ion, a nitrate ion, a sulfate ion, or a hydroxide ion may be mentioned. As the organic ion, an organic acid ion may be mentioned, and for example, a carboxylate ion may be mentioned.

In addition, the polyvalent metal compound is preferably an ionic polyvalent metal salt, and in particular, when the polyvalent metal salt is a magnesium salt or a calcium salt, a stability of the treatment liquid is made more preferable. In addition, as a counter ion of the polyvalent metal, either an inorganic acid ion or an organic acid ion may be used.

As a concrete example of the above polyvalent metal salt, for example, a calcium carbonate, such as a heavy calcium carbonate or a light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, aluminum acetate, calcium propionate, magnesium propionate, aluminum propionate, calcium lactate, magnesium lactate, or aluminum lactate may be mentioned. Those polyvalent metal salts may be used alone, or at least two types thereof may be used in combination. Among those mentioned above, since a sufficient solubility in water can be obtained, at least one of magnesium sulfate, calcium nitrate, aluminum lactate, and calcium propionate is preferable. In addition, those metal salts each may have hydrated water in the form of a raw material.

As a metal salt other than the polyvalent metal salt, a monovalent metal salt, such as sodium salt or a potassium salt, may be mentioned, and for example, sodium sulfate or potassium sulfate may be mentioned.

As the organic acid, for example, there may be preferably mentioned a poly(meth)acrylic acid, formic acid, acetic acid, propionic acid, glycol acid, oxalic acid, malonic acid, malic acid, maleic acid, ascorbic acid, succinic acid, glutaric acid, adipic acid, fumaric acid, citric acid, tartaric acid, lactic acid, pyruvic acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or a derivative or a salt of one of those acids mentioned above. The organic acids may be used alone, or at least two types thereof may be used in combination. An organic acid salt also functioning as a metal salt is included in the metal salt mentioned above.

As the inorganic acid, for example, sulfuric acid, hydrochloric acid, nitric acid, or phosphoric acid may be mentioned. The inorganic acids may be used alone, or at least two types thereof may be used in combination.

As the cationic resin (cationic polymer), for example, a cationic urethane-based resin, a cationic olefin-based resin, a cationic amine-based resin, or a cationic surfactant may be mentioned.

As the cationic urethane-based resin, a commercially available product may be used, and for example, Hydran CP-7010, CP-7020, CP-7030, CP-7040, CP-7050, CP-7060, or CP-7610 (trade name, manufactured by DIC Corporation); Superflex 600, 610, 620, 630, 640, or 650 (trade name, manufactured by DKS Co., Ltd.); or Urethane Emulsion WBR-2120C or WBR-2122C (trade name, manufactured by Taisei Fine Chemical Co., Ltd.) may be used.

The cationic olefin-based resin is a resin having a structural skeleton of an olefin, such as ethylene or propylene, and a known resin may be appropriately and selectively used. In addition, the cationic olefin-based resin may also be in the form of an emulsion in which the resin is dispersed in a solvent such as water or an organic solvent. As the cationic olefin-based resin, a commercially available product may be used, and for example, Arrowbase CB-1200 or CD-1200 (trade name, manufactured by Unitika Ltd.) may be mentioned.

As the cationic amine-based resin (cationic polymer), a resin having an amino group in its structure may be used, and a known resin may be appropriately and selectively used. For example, a polyamine resin, a polyamide resin, or a polyallylamine resin may be mentioned. The polyamine resin is a resin having an amino group in its main skeleton. The polyamide resin is a resin having an amide group in its main skeleton. The polyallylamine resin is a resin having a structure derived from an allyl group in its main skeleton.

In addition, as the cationic polyamine-based resin, for example, there may be mentioned Unisence KHE103L manufactured by Senka Corporation (hexamethylenediamine/epichlorohydrin resin, pH of 1%-water solution: approximately 5.0; viscosity: 20 to 50 (mPas); aqueous solution at a solid content concentration of 50 percent by mass) or Unisence KHE104L (dimethylamine/epichlorohydrin resin, pH of 1%—water solution: approximately 7.0; viscosity: 1 to 10 (mPas); aqueous solution at a solid content concentration of 20 percent by mass). Furthermore, as a concrete example of a commercially available product of the cationic polyamine-based resin, for example, there may be mentioned FL-14 (manufactured by SNF); Arafix 100, 251S, 255, or 255 LOX (manufactured by Arakawa Chemical Industries, Ltd.); DK-6810, 6853, or 6885, WS-4010, 4011, 4020, 4024, 4027, or 4030 (manufactured by Seiko PMC Corporation); Papyogene P-105 (manufactured by Senka Corporation); Sumirez resin 650(30), 675A, 6615, or SLX-1 (manufactured by Taoka Chemical Co., Ltd.); Catiomaster (registered trademark) PD-1, 7, 30, A, PDT-2, PE-10, PE-30, DT-EH, EPA-SK01, or TMHMDA-E (manufactured by Yokkaichi Chemical Company Limited); or Jetfix 36N, 38A, or 5052 (manufactured by Satoda Chemical Industrial Co., Ltd.).

As the polyallylamine resin, for example, there may be mentioned a polyallylamine hydrochloride, a polyallylamineamide sulfate, an allylamine hydrochloride-diallylamine hydrochloride copolymer, an allylamine acetate-diallylamine acetate copolymer, an allylamine hydrochloride-dimethylallylamine hydrochloride copolymer, an allylamine-dimethylallylamine copolymer, a polydiallylamine hydrochloride, a polymethyldiallylamine hydrochloride, a polymethyldiallylamineamide sulfate, a polymethyldiallylamine acetate, a polydiallyldimethylammonium chloride, a diallylamine acetate-sulfur dioxide copolymer, a diallylmethylethylammoniumethyl sulfate-sulfur dioxide copolymer, a methyldiallylamine hydrochloride-sulfur dioxide copolymer, a diallyldimethylammonium chloride-sulfur dioxide copolymer, or a diallyldimethylammonium chloride-acrylamide copolymer.

As the cationic surfactant, for example, there may be mentioned a primary, a secondary, or a tertiary amine salt type compound, an alkylamine salt, a dialkylamine salt, an aliphatic amine salt, a benzalkonium salt, a quaternary ammonium salt, a quaternary alkylammonium salt, an alkylpyridinium salt, a sulfonium salt, a phosphonium salt, an onium salt, or an imidazolinium salt. As a concrete example of the cationic surfactant mentioned above, for example, there may be mentioned a hydrochloride or an acetate of laurylamine, palm amine, or rosin amine, lauryltrimethylammonium chloride, cetyltrimethylammonium chloride, benzyltributylammonium chloride, benzalkonium chloride, dimethylethyllaurylammonium ethyl sulfate, dimethylethyloctylammonium ethyl sulfate, trimethyllaurylammonium hydrochloride, cetylpyridinium chloride, cetylpyridinium bromide, dihydroxyethyllaurylamine, decyldimethylbenzylammonium chloride, dodecyldimethylbenzylammonium chloride, tetradecyldimethylammonium chloride, hexadecyldimethylammonium chloride, or octadecyldimethylammonium chloride. In addition, although functioning as the aggregating agent which will be described later, the cationic surfactant may be contained in the ink jet ink composition. However, the cationic surfactant is more preferably contained in the treatment liquid as the aggregating agent.

At least two types of the aggregating agents mentioned above may be used in combination. In addition, among the aggregating agents mentioned above, when at least one of the polyvalent metal salt, the organic acid, and the cationic resin is selected, since the aggregating function is more preferable, an image having a higher image quality (in particular, a preferable color development property) can be formed.

A total content of the aggregating agent in the treatment liquid with respect to a total mass of the treatment liquid is, for example, 0.1 to 20 percent by mass, preferably 1 to 20 percent by mass and more preferably 2 to 15 percent by mass. In addition, when the aggregating agent is contained in the form of a solution or a dispersion, a solid content thereof is preferably in the range described above. When the content of the aggregating agent is 1 percent by mass or more, the aggregating agent is able to have a sufficient ability to aggregate the components contained in the ink. In addition, since the content of the aggregating agent is 30 percent by mass or less, the solubility and/or the dispersibility of the aggregating agent in the treatment liquid is made more preferable, and for example, a storage stability of the treatment liquid can be improved.

In addition, even when an organic solvent contained in the treatment liquid has a high hydrophobic property, since the solubility of the aggregating agent in the treatment liquid is made preferable, as the aggregating agent, a compound having a solubility of 1 g or more with respect to 100 g of water at 25° C. is preferably used, and a compound having a solubility of 3 to 80 g is more preferably used.

### Other Components

As long as the functions of the treatment liquid are not degraded, the treatment liquid may contain, besides the aggregating agent, components, such as a water-soluble low molecular weight organic compound, an organic solvent, a surfactant, water, a wax, an additive, an antiseptic agent/fungicide, an antirust agent, a chelating agent, an antioxidant, and/or an antifungal agent. Since the components described above are similar to those of the ink jet ink composition described above, detailed descriptions thereof will be omitted. The treatment liquid is preferably a water-based treatment liquid.

The treatment liquid may contain the low molecular weight organic compound A described above. In this case, the abrasion resistance, the image quality, and the like are preferably made more excellent.

In addition, the treatment liquid may contain the silicone-based surfactant which satisfies the condition (c) described above. In this case, the abrasion resistance, the image quality, and the like are preferably made more excellent. The conditions, such as the contents, of the low molecular weight organic compound A and the silicone-based surfactant which satisfies the condition (c) may be set similar to those described in the above ink.

The treatment liquid may be obtained such that the components described above are mixed together in an appropriate order, and if needed, impurities are removed by filtration or the like. As a mixing method of the components, a method in which the materials are added to a container equipped with a stirring device, such as a mechanical stirrer or a magnetic stirrer, and are then stirred and mixed together may be preferably used.

When the recording method includes a treatment liquid adhesion step of adhering the treatment liquid containing an aggregating agent to a recording medium, an image having a more preferable image quality can be obtained. In addition, the treatment liquid adhesion step is preferably performed prior to the ink adhesion step. Accordingly, the aggregating agent contained in the treatment liquid can be made to sufficiently function on the ink jet ink composition. In addition, the recording method of this embodiment may further include, if needed, at least one step of adhering at least one type of the treatment liquid and/or at least one type of the ink jet ink composition to the recording medium. The order and the number of those steps are not limited and, as needed, may be appropriately performed. In addition, in the case described above, the treatment liquid and each ink jet ink composition may be or may be not adhered to the same region of the recording medium. According to the recording method of this embodiment, an image having a high image quality and a preferable abrasion resistance can be formed.

### 2.3.2. Heating Step

### Primary Heating Step

The recording method of this embodiment may further include a heating step of heating the composition adhered to the recording medium. Accordingly, an image having a high image quality and a preferable abrasion resistance can be obtained, and in addition, an effect of a high recording rate can be more significantly obtained. The heating step as described above is called a primary heating step. The primary heating step is a step to rapidly heat and dry the ink jet ink composition (ink) adhered to the recording medium. The primary heating step is a heating step to evaporate at least a part of the solvent component of the ink composition adhered to the recording medium. The ink is adhered to a heated recording medium, or the recording medium is heated at an early stage after the ink is adhered to the recording medium, and within approximately one second after an ink droplet is adhered to the recording medium, the heating is started on this ink droplet.

The primary heating step may include a step of heating the recording medium before the treatment liquid adhesion step and/or the ink adhesion step or during the adhesion step. The primary heating step may be performed by a drying method using a heating mechanism. As the drying method using a heating mechanism, a method (ventilation method) to send an ordinary temperature wind or a hot wind to the recording medium, a method (radiation method) to radiate radioactive rays (infrared rays or the like) generating heat to the recording medium, or a member (conduction method) to conduct heat to the recording medium by contact therewith may be mentioned, and at least two of the methods described above may be used in combination. When the primary heating step is performed, among those methods described above, the primary heating step is more preferably performed by the radiation method. The primary heating step using a heating mechanism is a step to immediately promote the drying of the composition adhered to the recording medium.

As described below, the primary heating step is preferably performed by a heating mechanism disposed at a position to which immediately before or after each composition is adhered. Accordingly, since the heating of an ink jet head is suppressed, a clogging resistance is further improved, and the ejection stability is expected to be improved.

An upper limit of a surface temperature of the recording medium in the adhesion step of the ink jet ink composition is preferably 50° C. or less, more preferably 45.0° C. or less, even more preferably 43.0° C. or less, further preferably 40.0° C. or less, even further preferably 38.0° C. or less, particularly preferably 35.0° C. or less, even particularly preferably 32.0° C. or less, specifically preferably 30.0° C. or less, and more specifically preferably 28.0° C. or less. On the other hand, a lower limit of the surface temperature described above is preferably 20.0° C. or more, more preferably 23.0° C. or more, even more preferably 25.0° C. or more, further preferably 28.0° C. or more, even further preferably 30.0° C. or more, and particularly preferably 32.0° C. or more.

When the primary heating step is performed, the surface temperature of the recording medium by the primary heating is preferably in the range described above. In particular, the surface temperature described above is preferably 28.0° C. or more.

The temperature described above is a surface temperature of a portion of a recording surface of the recording medium in the adhesion step to which the composition is adhered and is the maximum temperature of a recording region in the adhesion step. When the surface temperature described above is the above upper limit or less, it is more preferable in terms of suppression of clogging and high glossiness. When the surface temperature described above is the above lower limit or more, it is more preferable in terms of excellent durability of an image and excellent image quality thereof due to good spreadability of the composition.

The surface temperature of the recording medium during the adhesion can be increased relatively high by performing the primary heating step using a heating mechanism and can be decreased relatively low without performing the primary heating step.

When being performed, the primary heating step can be simultaneously performed with at least one of the above adhesion steps. When the primary heating step is simultaneously performed with the adhesion step, the surface temperature of the recording medium is preferably set to 43.0° C. or less and more preferably set to 40.0° C. or less.

In the recording method of this embodiment, when the primary heating step to heat the ink jet ink composition adhered to the recording medium is included, an image having preferable image quality and abrasion resistance can be obtained with a more preferable drying property.

### Post-Heating Step

The ink jet recording method according to this embodiment may further include, after the primary heating step is performed following each adhesion step described above, a post-heating step of heating the recording medium. The post-heating step is also called a secondary heating step. In the post-heating step, the heating is started approximately more than one second after all inks to be adhered to a certain region of the recording medium are adhered thereto.

The post-heating step may be performed using an appropriate heating device. The post-heating step is performed, for example, using an after heater (corresponding to a heating heater 5 in the following example of an ink jet recording apparatus 1). In addition, the heating device is not limited to a heating device equipped in the ink jet recording apparatus, and another drying device may also be used. Accordingly, since an image to be obtained can be dried and can be more sufficiently fixed, for example, a recorded matter can be rapidly placed in a ready to use state.

Although the temperature of the recording medium in this case is not particularly limited, for example, the temperature described above may be determined in consideration of a glass transition temperature (Tg) or the like of a resin component forming resin particles contained in the recorded matter. When the Tg of the resin component forming the water-dispersible resin or the wax is taken into consideration, the temperature of the recording medium described above may be set to be higher than the Tg of the resin component by 5.0° C. or more and preferably by 10.0° C. or more.

A surface temperature of the recording medium obtained by the heating in the post-heating step is 30.0° C. to 120.0° C., preferably 40.0° C. to 100.0° C., more preferably 50.0° C. to 95° C., and further preferably 70° C. to 90° C. The surface temperature of the recording medium obtained by the heating in the post-heating step is particularly preferably 80° C. or more. When the temperature of the recording medium is approximately in the range as described above, film formation and planarization of the resin particles contained in the recorded matter can be performed, and in addition, an image to be obtained can be dried and can be more sufficiently fixed.

### 2.3.3. Laminating Step

The recorded matter obtained by the recording method described above may be used after a laminating treatment is performed on a recorded surface of the recorded matter. A laminating step to perform lamination on the recording medium may be performed by film lamination such that a film is adhered on a recording surface of the recording medium to which the ink jet ink composition is adhered. In addition, although the laminating step is not particularly limited, after a known adhesive is adhered to a recorded surface of a recorded matter, a film may be adhered thereto, or a film to which an adhesive is adhered may be adhered to a recorded surface of a recorded matter. In addition, by extruding a molten resin obtained by melting a film onto a recorded surface of a recorded matter, a film may be formed on the recorded surface of the recorded matter. As a material of a film or the like used for lamination, for example, a resin-made film may be used. Since the recorded matter is laminated, the abrasion resistance of the recorded matter is further improved, and in addition, when the recorded matter is handled in an inadequate manner such as being brought into contact with a solid material, the protection performance is preferably excellent. In addition, after the recorded matter and the film are adhered to each other, the adhesion therebetween is preferably made sufficient by compression performed with heating or at ordinary temperature.

### 3. Ink Jet Recording Apparatus

One example of an ink jet recording apparatus preferably used in the recording method according to this embodiment will be described with reference to the drawings. The ink jet recording apparatus includes an ink jet head to perform an ink adhesion step of an ink jet ink composition and a primary heating mechanism. In addition, the ink jet recording apparatus described above is able to perform the above recording method.

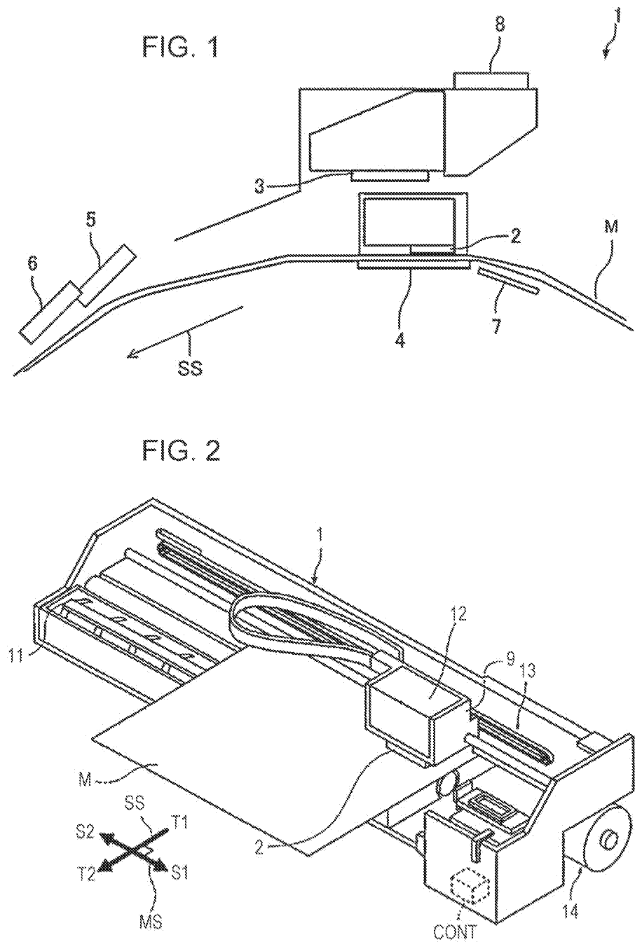

FIG. 1 is a cross-sectional view schematically showing an ink jet recording apparatus 1. FIG. 2 is a perspective view showing one example of the structure of a carriage and its vicinity of the ink jet recording apparatus 1 shown in FIG. 1. As shown in FIGS. 1 and 2, the ink jet recording apparatus 1 includes an ink jet head 2, an IR heater 3, a platen heater 4, a heating heater 5, a cooling fan 6, a pre-heater 7, a ventilation fan 8, a carriage 9, a platen 11, a carriage transfer mechanism 13, a transport device 14, and a control portion CONT. In the ink jet recording apparatus 1, all operations thereof are controlled by the control portion CONT shown in FIG. 2.

The ink jet head 2 has a structure to perform recording on a recording medium M by ejecting a treatment liquid and an ink jet ink composition from nozzles of the ink jet head 2 so as to be adhered thereto. In this embodiment, the ink jet head 2 is a serial type ink jet head and adheres the ink to the recording medium M by a plurality of scannings in a main scanning direction relative to the recording medium M. The ink jet head 2 is mounted on the carriage 9 shown in FIG. 2. The ink jet head 2 is scanned a plurality of times in the main scanning direction relative to the recording medium M by the operation of the carriage transfer mechanism 13 to transfer the carriage 9 in a medium width direction of the recording medium M. The medium width direction is the main scanning direction of the ink jet head 2. The scanning in the main scanning direction is also called a main scanning.

In addition, the main scanning direction is a direction in which the carriage 9 mounting the ink jet head 2 is transferred. In FIG. 1, the main scanning direction is a direction intersecting a sub-scanning direction which is a transport direction of the recording medium M shown by an arrow SS. In FIG. 2, the width direction of the recording medium M, that is, a direction represented by S1-S2, is a main scanning direction MS, and a direction represented by T1→T2 is a sub-scanning direction SS. In addition, by one scanning, the scanning is performed in the main scanning direction, that is, in one direction represented by an arrow S1 or an arrow S2. In addition, since the main scanning of the ink jet head 2 and the sub-scanning which is the transport of the recording medium M are repeatedly performed at least two times, the ink is recorded on the recording medium M. That is, the treatment liquid adhesion step and the ink adhesion step are performed by a plurality of main scannings in each of which the ink jet head 2 is transferred in the main scanning direction and a plurality of sub-scannings in each of which the recording medium M is transported in the sub-scanning direction intersecting the main scanning direction.

The cartridge 12 to supply the ink jet ink composition and the treatment liquid to the ink jet head 2 includes a plurality of independent cartridges. The cartridge 12 is detachably fitted to the carriage 9 mounting the ink jet head 2. In the cartridges, different types of ink jet ink compositions and treatment liquids are filled, and the ink jet ink compositions and the treatment liquids are supplied to individual nozzles from the cartridge 12. In addition, in this embodiment, although the case in which the cartridge 12 is fitted to the carriage 9 is shown by way of example, the cartridge 12 is not limited thereto and may be provided at a position other than the carriage 9 so that the ink jet ink compositions and the treatment liquids are each supplied to the nozzle by a supply tube not shown.

For the ejection by the ink jet head 2, a known method may be used. In this embodiment, a method to eject a liquid droplet using vibration of a piezoelectric element, that is, an ejection method to form an ink droplet by a mechanical deformation of a piezoelectric element, is used.

The ink jet recording apparatus 1 includes the IR heater 3 and the platen heater 4 each of which heats the recording medium M when the ink jet ink composition is ejected from the ink jet head 2. By the IR heater 3 or the platen heater 4, the primary heating step can be performed. Furthermore, in this embodiment, when the recording medium M is dried in the primary heating step, for example, the ventilation fan 8 which will be described later may be used.

In addition, when the IR heater 3 is used, the recording medium M can be heated using a method to radiate infrared rays from an ink jet head 2 side. Accordingly, although the ink jet head 2 is also liable to be simultaneously heated, compared to the case in which heating is performed from a rear surface of the recording medium M by the platen heater 4 or the like, the temperature can be increased without receiving the influence of the thickness of the recording medium M. In addition, there may be provided various types of fans (such as the ventilation fan 8) to dry the ink on the recording medium M by supplying a hot wind or a wind having the same temperature as that in the environment to the recording medium M.

When the treatment liquid or the ink jet ink composition ejected from the ink jet head 2 is adhered to the recording medium M, in order to dry the treatment liquid or the ink jet ink composition at an early stage, the platen heater 4 is able to heat the recording medium M at a position facing the ink jet head 2 with the platen 11 interposed therebetween. The platen heater 4 is able to heat the recording medium M by a conduction method, and in the recording method of this embodiment, the ink jet ink composition can be adhered to the recording medium M heated as described above (primary heating). Hence, the ink jet ink composition can be rapidly fixed on the recording medium M, and the image quality thereof can be improved.

The heating heater 5 dries and solidifies the treatment liquid or the ink jet ink composition adhered to the recording medium M, that is, the heating heater 5 is a secondary heating heater or a secondary drying heater. The heating heater 5 can be used in the post-heating step. Since the heating heater 5 heats the recording medium M on which an image is recorded, for example, moisture contained in the ink jet ink composition is more rapidly evaporated, and an ink film is formed by the resin contained in the ink jet ink composition. As described above, the ink film is tightly fixed or adhered onto the recording medium M so as to have an excellent film forming property, and an image having an excellent high image quality can be obtained in a short period.

The ink jet recording apparatus 1 may also include the cooling fan 6. After the ink jet ink composition recorded on the recording medium M is dried, the ink jet ink composition on the recording medium M is cooled by the cooling fan 6, and hence, an ink coating film can be formed to have an excellent adhesion onto the recording medium M.

In addition, the ink jet recording apparatus 1 may also include the pre-heater 7 to heat the recording medium M in advance before the ink jet ink composition is adhered to the recording medium M. Furthermore, the ink jet recording apparatus 1 may also include the ventilation fan 8 so as to efficiently dry the ink jet ink composition adhered to the recording medium M.

At a lower side of the carriage 9, there are provided the platen 11 to support the recording medium M, the carriage transfer mechanism 13 to transfer the carriage 9 relative to the recording medium M, and the transport device 14 which is a roller to transport the recording medium M in the sub-scanning direction. The operations of the carriage transfer mechanism 13 and the transport device 14 are controlled by the control portion CONT.

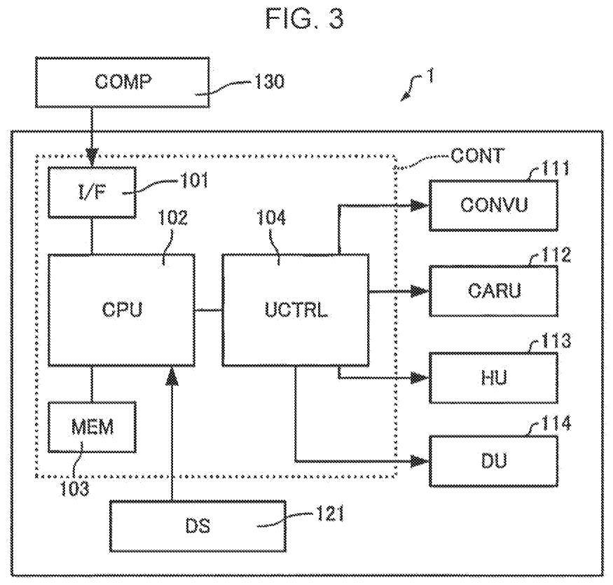

FIG. 3 is a functional block diagram of the ink jet recording apparatus 1. The control portion CONT is a control unit to control the ink jet recording apparatus 1. An interface portion 101 (I/F) functions to send and receive data between a computer 130 (COMP) and the ink jet recording apparatus 1. A CPU 102 is an arithmetic processing device to control the entire ink jet recording apparatus 1. A memory 103 (MEM) is to secure, for example, a region in which a program of the CPU 102 is stored and an operation region thereof. The CPU 102 controls individual units by a unit control circuit 104 (UCTRL). In addition, the status in the ink jet recording apparatus 1 is monitored by a detector group 121 (DS), and based on the detection result thereof, the control portion CONT controls the individual units.

A transport unit 111 (CONVU) controls the sub-scanning (transport) of the ink jet recording and in particular, controls a transport direction and a transport rate of the recording medium M. In particular, by controlling a rotation direction and a rotation rate of a transport roller driven by a motor, the transport direction and the transport rate of the recording medium M are controlled.

A carriage unit 112 (CARU) controls the main scanning (pass) of the ink jet recording and in particular, reciprocally transfers the ink jet head 2 in the main scanning direction. The carriage unit 112 includes the carriage 9 mounting the ink jet head 2 and the carriage transfer mechanism 13 to reciprocally transfer the carriage 9.

A head unit 113 (HU) controls an ejection amount of the ink jet ink composition from a nozzle of the ink jet head 2. For example, when the nozzle of the ink jet head 2 is driven by a piezoelectric element, the operation of the piezoelectric element of each nozzle is controlled. By the head unit 113, for example, a timing of each ink adhesion and a dot size of the ink jet ink composition are controlled. In addition, by combination of controls by the carriage unit 112 and the head unit 113, an adhesion amount of the ink jet ink composition per one scanning is controlled.

A drying unit 114 (DU) controls the temperatures of various types of heaters, such as the IR heater 3, the pre-heater 7, the platen heater 4, and the heating heater 5.

In the ink jet recording apparatus 1 described above, an operation in which the carriage 9 mounting the ink jet head 2 is transferred in the main scanning direction and a transport operation (sub-scanning) are alternately repeated. In this step, when each pass is performed, the control portion CONT controls the carriage unit 112 to transfer the ink jet head 2 in the main scanning direction and also controls the head unit 113 to eject a liquid droplet of the ink jet ink composition from a predetermined nozzle hole of the ink jet head 2 so as to adhere the liquid droplet to the recording medium M. In addition, the control portion CONT controls the transport unit 111 so that in the transport operation, the recording medium M is transported by a predetermined transport amount (feed amount) in the transport direction.

In the ink jet recording apparatus 1, since the main scanning (pass) and the sub-scanning (transport operation) are repeatedly performed, a recording region to which liquid droplets are adhered is gradually transported. Subsequently, by the after heater 5, the liquid droplets adhered to the recording medium M are dried, so that an image is completed. Next, the recorded matter thus completed may be wound into a roll shape by a winding mechanism or may be transported by a flatbed mechanism.

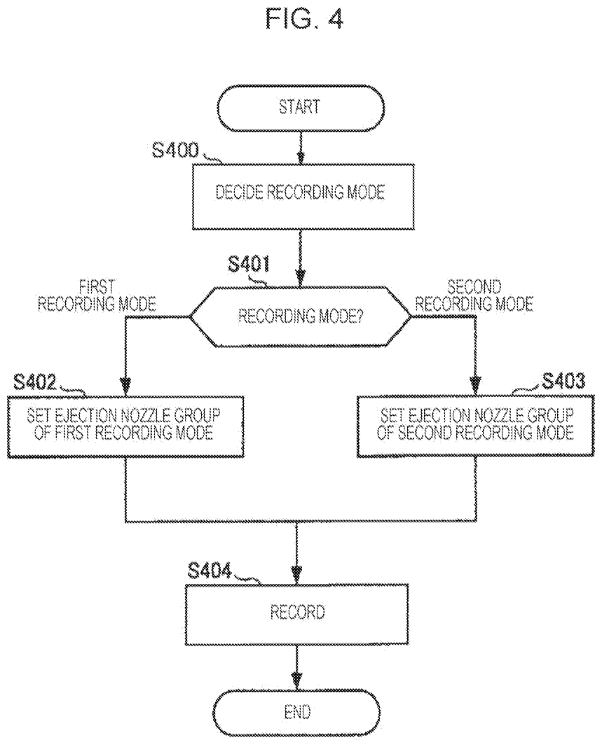

FIG. 4 is an example of a flowchart showing a process to be performed when recording is performed by the ink jet recording apparatus. When the recoding is started, the control portion of the ink jet recording apparatus decides a recording mode in Step 400. The recording mode is a recording mode in which details of the recording, such as arrangement of nozzles, an ejection amount, an overlap printing mode, an operation of the ink jet head in the recording, an operation of the recording medium, and a control of the heating mechanism, are determined. In the details of the recording described above, the number of passes (the number of the main scannings performed on the same recording region of the recording medium) for the recording is also included.

The decision of the recording mode is performed by an input signal input from an external apparatus, such as a computer, to the ink jet recording apparatus or by input information of a user to a user input portion of the ink jet recording apparatus. In this case, the input signal from the external apparatus or the input information of the user may be information to directly designate the recording mode or may be information relating to the recording, such as information on type of recording medium on which recording is performed, designation of a recording rate, and/or designation of an image quality. In addition, the information relating to the recoding is not limited to those described above. In the latter case, the ink jet recording apparatus records in advance, for example, in the control portion thereof, correspondence information in which a recording mode corresponding to the information relating to the recording is determined and decides a recording mode with reference to the correspondence information. Alternatively, the recording mode may be decided using an AI technique (artificial intelligence technique).

In Step S401, the decided recording mode is discriminated. In Step S402 or Step S403, in accordance with the decided recording mode, the number of passes is set. In Step S404, the recording is carried out. As the type of recording mode, although two recording modes, that is, a first recording mode and a second recording mode, are shown in the drawing, the number of recording modes may also be at least three.

In this example, the recording apparatus is able to change the number of passes (the number of the main scannings performed in the same recording region of the recording medium) in accordance with the recording mode, and various types of recordings can be preferably performed.

According to the ink jet recording apparatus described above by way of example, the recording method of this embodiment can be preferably performed. 4. Examples

Hereinafter, although the present disclosure will be described in more detail with reference to Examples, the present disclosure is not limited thereto. Hereinafter, “%” is represented on mass basis unless otherwise particularly noted.

### 4.1. Preparation of Pigment Dispersion

In a flask equipped with a dripping funnel, a nitrogen introduction tube, a reflux condenser, a thermometer, and a stirrer, 50 g of methyl ethyl ketone (MEK) was charged and then heated to 75° C. with nitrogen bubbling. In this flask, a mixture of monomers, that is, 80 g of butyl methacrylate, 50 g of methyl methacrylic acid, 15 g of styrene, and 20 g of methacrylic acid; 50 g of MEK; and 500 mg of a polymerization initiator (azobisisobutyronitrile:AIBN) was dripped by the dripping funnel over 3 hours. After the dripping was finished, heat reflux was performed for 6 hours, and after spontaneous cooling, MEK was then added to compensate for the loss thereof caused by evaporation, so that a resin solution (resin solid content: 50 percent by mass, acid value: 79 mg/KOH, Tg: 65° C.) was obtained. Subsequently, after 20 g of this solution was neutralized with a predetermined amount of a sodium hydroxide aqueous solution at a concentration of 20 percent by mass functioning as a neutralizer so as to neutralize 100% of salt-forming groups, 50 g of a pigment (carbon black) was gradually added thereto with stirring, and then kneading was performed using a bead mill for 2 hours. After 200 g of ion exchange water was added to a kneaded product thus obtained and stirred, MEK was distilled off by heating in a reduced-pressure environment. Furthermore, the concentration was adjusted with ion exchange water, so that a pigment dispersion (pigment solid content: 20 percent by mass, resin solid content: 5 percent by weight) was obtained.

### 4.2. Preparation of Ink Jet Ink Composition

After components were charged in a container to have one of the compositions shown in Tables 3 and 4 and were then mixed and stirred for 2 hours by a magnetic stirrer, filtration was performed using a membrane filter having a pore diameter of 5 μm, so that ink jet ink compositions (Ink A to Ink X) according to Examples and Comparative Examples were obtained.

TABLE 3

| | | | INK A | INK B | INK C | INK J | INK K | INK N |
|---|---|---|---|---|---|---|---|---|
| LOW MOLECULAR WEIGHT | | CPL | 4.0 | — | — | 4.0 | 4.0 | 8.0 |
| ORGANIC COMPOUND A | | MSF | — | 4.0 | — | — | — | — |
| | | EOXM | — | — | 4.0 | — | — | — |
| OTHERS | OTHER LOW | 2P | — | — | — | — | — | — |
| | MOLECULAR | CHP | — | — | — | — | — | — |
| | WEIGHT | DMPA | — | — | — | — | — | — |
| | ORGANIC | DMSO | — | — | — | — | — | — |
| | COMPOUNDS | DMIS | — | — | — | — | — | — |
| | OTHER | 1,2BD | — | — | — | — | — | — |
| | ORGANIC | 1,2HD | 4.0 | 4.0 | 4.0 | 4.0 | 4.0 | 4.0 |
| | SOLVENTS | PG | 15.0 | 15.0 | 15.0 | 15.0 | 15.0 | 15.0 |
| ALKANOLAMINE | | TIPA | 1.0 | 1.0 | 1.0 | 1.0 | 1.0 | 1.0 |
| PIGMENT DISPERSION | | BLACK | 4.0 | 4.0 | 4.0 | 4.0 | 4.0 | 4.0 |
| LIQUID | | PIGMENT | | | | | | |
| RESIN | STYRENE- | JONCRYL | 6.0 | 6.0 | 6.0 | 6.0 | 6.0 | 6.0 |
| | ACRYLIC | 631 | | | | | | |
| | BASE | | | | | | | |
| | POLYOLEFIN | HITECK | 0.5 | 0.5 | 0.5 | 0.5 | 0.5 | 0.5 |
| | BASE | E-6500 | | | | | | |
| SURFACTANT | SILICONE | BYK-3420 | 0.5 | 0.5 | 0.5 | — | 0.3 | 0.5 |
| | BASE | BYK-3480 | — | — | — | 0.2 | — | — |
| OTHER | SILICONE | BYK-348 | — | — | — | — | 0.2 | — |
| SURFACTANTS | BASE | | | | | | | |
| | ANIONIC | Disponil SUS | — | — | — | — | — | — |
| | BASE | IC 875 | | | | | | |
| DEFOAMING | ACETYLENE | SURFYNOL | 0.1 | 0.1 | 0.1 | 0.1 | 0.1 | 0.1 |
| AGENT | BASE | DF110D | | | | | | |
| PURE WATER | | | BALANCE | BALANCE | BALANCE | BALANCE | BALANCE | BALANCE |
| TOTAL | | | 100 | 100 | 100 | 100 | 100 | 100 |
| TOTAL OF WATER-SOLUBLE LOW | | | 19.0 | 23.0 | 23.0 | 19.0 | 19.0 | 19.0 |
| MOLECULAR WEIGHT ORGANIC | | | | | | | | |
| COMPOUNDS | | | | | | | | |
| STORAGE STABILITY | | | A | B | B | A | A | B |
| | | | INK O | INK P | INK Q | INK R | INK S | INK T |
| LOW MOLECULAR WEIGHT | | CPL | 4.0 | 4.0 | 4.0 | 4.0 | 4.0 | 2.0 |
| ORGANIC COMPOUND A | | MSF | — | — | — | — | — | — |
| | | EOXM | — | — | — | — | — | — |
| OTHERS | OTHER LOW | 2P | — | — | — | — | — | — |
| | MOLECULAR | CHP | — | — | — | — | — | — |
| | WEIGHT | DMPA | — | — | — | — | — | — |
| | ORGANIC | DMSO | — | — | — | — | — | — |
| | COMPOUNDS | DMIS | — | — | — | — | — | — |
| | OTHER | 1,2BD | — | — | — | — | — | — |
| | ORGANIC | 1,2HD | 8.0 | 4.0 | 4.0 | 4.0 | 4.0 | 4.0 |
| | SOLVENTS | PG | 15.0 | 8.0 | 15.0 | 15.0 | 15.0 | 15.0 |
| ALKANOLAMINE | | TIPA | 1.0 | 1.0 | 1.0 | 1.0 | 1.0 | 1.0 |
| PIGMENT DISPERSION | | BLACK | 4.0 | 4.0 | 4.0 | 4.0 | 4.0 | 4.0 |
| LIQUID | | PIGMENT | | | | | | |
| RESIN | STYRENE- | JONCRYL | 6.0 | 6.0 | 6.0 | 6.0 | 2.0 | 6.0 |
| | ACRYLIC | 631 | | | | | | |
| | BASE | | | | | | | |
| | POLYOLEFIN | HITECK | 0.5 | 0.5 | 0.5 | 0.5 | 0.5 | 0.5 |
| | BASE | E-6500 | | | | | | |
| SURFACTANT | SILICONE | BYK-3420 | 0.5 | 0.5 | 0.8 | 0.3 | 0.5 | 0.5 |
| | BASE | BYK-3480 | — | — | — | — | — | — |
| OTHER | SILICONE | BYK-348 | — | — | — | — | — | — |
| SURFACTANTS | BASE | | | | | | | |
| | ANIONIC | Disponil SUS | — | — | — | 0.2 | — | — |
| | BASE | IC 875 | | | | | | |
| DEFOAMING | ACETYLENE | SURFYNOL | 0.1 | 0.1 | 0.1 | 0.1 | 0.1 | 0.1 |
| AGENT | BASE | DF110D | | | | | | |

| | | | | | | |
|---|---|---|---|---|---|---|
| PURE WATER | BALANCE | BALANCE | BALANCE | BALANCE | BALANCE | BALANCE |
| TOTAL | 100 | 100 | 100 | 100 | 100 | 100 |
| TOTAL OF WATER-SOLUBLE LOW | 23.0 | 12.0 | 19.0 | 19.0 | 19.0 | 19.0 |
| MOLECULAR WEIGHT ORGANIC | | | | | | |
| COMPOUNDS | | | | | | |
| STORAGE STABILITY | B | A | A | A | A | A |

TABLE 4

| | | | INK X | INK D | INK E | INK F | INK G | INK H |
|---|---|---|---|---|---|---|---|---|
| LOW MOLECULAR WEIGHT | | CPL | 4.0 | — | — | — | — | — |
| ORGANIC COMPOUND A | | MSF | — | — | — | — | — | — |
| | | EOXM | — | — | — | — | — | — |
| OTHERS | OTHER LOW | 2P | 2.0 | 4.0 | — | — | — | — |
| | MOLECULAR | CHP | — | — | 4.0 | — | — | — |
| | WEIGHT | DMPA | — | — | — | 4.0 | — | — |
| | ORGANIC | DMSO | — | — | — | — | 4.0 | — |
| | COMPOUNDS | DMIS | — | — | — | — | — | 4.0 |
| | OTHER | 1,2BD | — | — | — | — | — | — |
| | ORGANIC | 1,2HD | 4.0 | 4.0 | 4.0 | 4.0 | 4.0 | 4.0 |
| | SOLVENTS | PG | 15.0 | 15.0 | 15.0 | 15.0 | 15.0 | 15.0 |
| ALKANOLAMINE | | TIPA | 1.0 | 1.0 | 1.0 | 1.0 | 1.0 | 1.0 |
| PIGMENT DISPERSION | | BLACK | 4.0 | 4.0 | 4.0 | 4.0 | 4.0 | 4.0 |
| LIQUID | | PIGMENT | | | | | | |
| RESIN | STYRENE- | JONCRYL | 6.0 | 6.0 | 6.0 | 6.0 | 6.0 | 6.0 |
| | ACRYLIC | 631 | | | | | | |
| | BASE | | | | | | | |
| | POLYOLEFIN | HITECK | 0.5 | 0.5 | 0.5 | 0.5 | 0.5 | 0.5 |
| | BASE | E-6500 | | | | | | |
| SURFACTANT | SILICONE | BYK-3420 | 0.5 | 0.5 | 0.5 | 0.5 | 0.5 | 0.5 |
| | BASE | BYK-3480 | — | — | — | — | — | — |
| OTHER | SILICONE | BYK-348 | — | — | — | — | — | — |
| SURFACTANTS | BASE | | | | | | | |
| | ANIONIC | Disponil SUS | — | — | — | — | — | — |
| | BASE | IC 875 | | | | | | |
| DEFOAMING | ACETYLENE | SURFYNOL | 0.1 | 0.1 | 0.1 | 0.1 | 0.1 | 0.1 |
| AGENT | BASE | DF110D | | | | | | |
| PURE WATER | | | BALANCE | BALANCE | BALANCE | BALANCE | BALANCE | BALANCE |
| TOTAL | | | 100 | 100 | 100 | 100 | 100 | 100 |
| TOTAL OF WATER-SOLUBLE LOW | | | 21.0 | 23.0 | 23.0 | 23.0 | 23.0 | 23.0 |
| MOLECULAR WEIGHT ORGANIC | | | | | | | | |
| COMPOUNDS | | | | | | | | |
| STORAGE STABILITY | | | A | A | A | B | B | B |
| | | | INK I | INK L | INK M | INK U | INK V | INK W |
| LOW MOLECULAR WEIGHT | | CPL | — | 4.0 | 4.0 | — | — | — |
| ORGANIC COMPOUND A | | MSF | — | — | — | — | — | — |
| | | EOXM | — | — | — | — | — | — |
| OTHERS | OTHER LOW | 2P | — | — | — | 4.0 | — | — |
| | MOLECULAR | CHP | — | — | — | — | 4.0 | — |
| | WEIGHT | DMPA | — | — | — | — | — | — |
| | ORGANIC | DMSO | — | — | — | — | — | — |
| | COMPOUNDS | DMIS | — | — | — | — | — | — |
| | OTHER | 1,2BD | — | — | — | — | — | 4.0 |
| | ORGANIC | 1,2HD | 4.0 | 4.0 | 4.0 | 4.0 | 4.0 | 4.0 |
| | SOLVENTS | PG | 19.0 | 15.0 | 15.0 | 15.0 | 15.0 | 15.0 |
| ALKANOLAMINE | | TIPA | 1.0 | 1.0 | 1.0 | 1.0 | 1.0 | 1.0 |
| PIGMENT DISPERSION | | BLACK | 4.0 | 4.0 | 4.0 | 4.0 | 4.0 | 4.0 |
| LIQUID | | PIGMENT | | | | | | |
| RESIN | STYRENE- | JONCRYL | 6.0 | 6.0 | 6.0 | 6.0 | 6.0 | 6.0 |
| | ACRYLIC | 631 | | | | | | |
| | BASE | | | | | | | |
| | POLYOLEFIN | HITECK | 0.5 | 0.5 | 0.5 | 0.5 | 0.5 | 0.5 |
| | BASE | E-6500 | | | | | | |
| SURFACTANT | SILICONE | BYK-3420 | 0.5 | — | — | — | — | 0.5 |
| | BASE | BYK-3480 | — | — | — | — | — | — |
| OTHER | SILICONE | BYK-348 | — | 0.5 | — | 0.5 | 0.5 | — |
| SURFACTANTS | BASE | | | | | | | |
| | ANIONIC | Disponil SUS | — | — | — | — | — | — |
| | BASE | IC 875 | | | | | | |
| DEFOAMING | ACETYLENE | SURFYNOL | 0.1 | 0.1 | 0.1 | 0.1 | 0.1 | 0.1 |
| AGENT | BASE | DF110D | | | | | | |

| | | | | | | |
|---|---|---|---|---|---|---|
| PURE WATER | BALANCE | BALANCE | BALANCE | BALANCE | BALANCE | BALANCE |
| TOTAL | 100 | 100 | 100 | 100 | 100 | 100 |
| TOTAL OF WATER-SOLUBLE LOW | 23.0 | 19.0 | 19.0 | 23.0 | 23.0 | 23.0 |
| MOLECULAR WEIGHT ORGANIC | | | | | | |
| COMPOUNDS | A | A | A | A | A | A |
| STORAGE STABILITY | | | | | | |

The abbreviations and the like in Tables 3 and 4 are as shown below.
CPL: ε-caprolactam, standard boiling point: 267° C., (mixture surface tension: 54.1) (cyclic amide)
MSF: 3-methylsulfolane, standard boiling point: 276° C., (mixture surface tension: 51.7), (sulfur-containing compound)
EOXM: 3-ethyl-3-oxetanemethanol, standard boiling point: 220° C., (mixture surface tension: 47.8) (cyclic ether)
2P: 2-pyrrolidone, standard boiling point: 245° C., (mixture surface tension: 60.2) (cyclic amide)
CHP: N-cyclohexyl-2-pyrrolidone, standard boiling point: 290° C., (mixture surface tension: 40.8) (cyclic amide)
DMPA: 3-methoxy-N,N-dimethylpropaneamide, standard boiling point: 215° C., (mixture surface tension: 57.8) (chain amide)
DMSO: dimethylsulfoxide, standard boiling point: 189° C., (mixture surface tension: 68.0) (sulfur-containing compound)
DMIS: dimethylisosorbide, standard boiling point: 240° C., (mixture surface tension: 58.0) (cyclic ether)
1,2BD: 1,2-butanediol, standard boiling point: 192° C., (mixture surface tension: 51.3) (alkanediol)
1,2HD: 1,2-hexanediol, standard boiling point: 224° C., (mixture surface tension: 26.9) (alkanediol)
PG: propylene glycol, standard boiling point: 188° C., (mixture surface tension: 61.2) (alkanediol)
TIPA: triisopropanolamine, standard boiling point: 301° C., (mixture surface tension: 45.4) (alkanolamine)
Joncryl 631: styrene-acrylic-based resin emulsion, manufactured by BASF Japan
Hitech E-6500: polyethylene-based wax emulsion, manufactured by Toho Chemical Industry Co., Ltd.
BYK-3420: silicone-based surfactant, (solubility: 0.1% to 0.5%), manufactured by BYK Japan KK
BYK-3480: silicone-based surfactant, (solubility: less than 0.1%), manufactured by BYK Japan KK
BYK-348: silicone-based surfactant, (solubility: more than 1%), manufactured by BYK Japan KK
Disponil SUS IC 875: anionic surfactant according to the general formula (1), manufactured by BASF Japan
Surfynol DF110D: acetylene glycol-based surfactant (defoaming agent), manufactured by Nisshin Chemical Industry Co., Ltd.

In addition, the mixture surface tension described above was a surface tension obtained in a manner such that as a test solution, after an aqueous solution at a concentration of 10 percent by mass was prepared from each of the low molecular weight organic compounds and the organic solvents, a surface tension (mN/m) obtained when a platinum plate was wetted with the ink in an environment at 20° C. was confirmed using an automatic surface tensiometer CBVP-Z (trade name, manufactured by Kyowa Interface Science Co., Ltd.).

### 4.3. Preparation of Treatment Liquid

After components were charged in a container to have one of the compositions shown in Table 5 and were then mixed and stirred for 2 hours by a magnetic stirrer, filtration was performed using a membrane filter having a pore diameter of 5 μm, so that treatment liquids (treatment liquids A to C) were obtained.

TABLE 5

| | | | TREATMENT | TREATMENT | TREATMENT |
|---|---|---|---|---|---|
| | | | LIQUID A | LIQUID B | LIQUID C |
| LOW MOLECULAR WEIGHT | | CPL | 4.0 | 4.0 | 4.0 |
| ORGANIC COMPOUND A | | | | | |
| ORGANIC SOLVENT | | 1,2HD | 4.0 | 4.0 | 4.0 |
| | | PG | 15.0 | 15.0 | 15.0 |
| AGGREGATING | DICARBOXYLIC | SUCCINIC ACID | 0.1 | 0.1 | 4.0 |
| AGENT | ACID | | | | |
| | POLYVALENT | CALCIUM | 5.0 | — | 5.0 |
| | METAL SALT | PROPIONATE | | | |
| | CATIONIC RESIN | CATIOMASTER | — | 3.0 | — |
| | | PD-7 | | | |
| SURFACTANT | SILICONE BASE | BYK-3420 | 1.0 | 1.0 | 1.0 |
| DEFOAMING | ACETYLENE | SURFYNOL | 0.1 | 0.1 | 0.1 |
| AGENT | BASE | DF110D | | | |

| | | | |
|---|---|---|---|
| PURE WATER | BALANCE | BALANCE | BALANCE |
| TOTAL | 100 | 100 | 100 |

The abbreviations and the like in Table 5 are as shown below.

“Catiomaster PD-7”: amine/epichlorohydrin-based cationic resin, manufactured by Yokkaichi Chemical Company Limited.

In addition, the dicarboxylic acid is classified in the organic acid. The other compounds are described in the abbreviations and the like of Tables 3 and 4.

### 4.4. Evaluation Method

### 4.4.1. Recording Test

Recorded matters of Examples and Comparative Examples were formed under the following printing conditions.

### Printing Conditions

Printing machine: modified machine of “SC-R5050”, manufactured by Seiko Epson Corporation

Resolution: 1,200×1,200 dpi

Adhesion amount: ink composition (18 mg/inch²), treatment liquid (2 mg/inch²)

Printing pattern: solid pattern (black monocolor (color ink))

Number of scannings: 9 times

Platen heating temperature (primary heating): shown in Table 6.

Post-heating temperature (secondary heating): 80° C.

Recording medium: “3686, Trisolv Poster Paper”, (coated paper, manufactured by Sihl Inc.)

Platen gap: 1.7 mm

After the ink and the treatment liquid were filled in nozzle lines of a head of the printing apparatus described above, recording was performed. In an example using the treatment liquid, the ink and the treatment liquid were ejected by the same main scanning and were adhered to the same main scanning region.

### 4.4.2. Evaluation of Image Quality (Color Development)

Under the recording test conditions, the recording medium was set, and the solid pattern was printed. An OD value was measured by a colorimeter i1 iO2 (manufactured by X-Rite) (D50 was used as a light source). Evaluation was performed by the following criteria, and the results are shown in Table 6.

AA: OD value is 2.1 or more.

A: OD value is 2.0 to less than 2.1.

B: OD value is 1.8 to less than 2.0.

C: OD value is less than 1.8.

### 4.4.3. Evaluation of Image Quality (Aggregation Irregularity)

Under the recording test conditions, after the recording medium was set, the solid pattern was printed, and a printed matter thus obtained was observed by visual inspection. Evaluation was performed by the following criteria, and the results are shown in Table 6.

AA: No aggregation irregularity is observed (uniform).
A: Although being slightly observed, aggregation irregularity is not apparent.
B: Although being apparent, aggregation irregularity is acceptable.
C: Aggregation irregularity is apparent. In addition, an edge portion of the recorded pattern is not a straight line, and the ink overflows.

In addition, the aggregation irregularity indicates the state in which the color of the ink looks non-uniform in the solid pattern.

### 4.4.4. Evaluation of Abrasion Resistance

After the solid pattern was printed on the recording medium under the recording test conditions and was then left for 30 minutes at room temperature, a solid pattern printed portion was cut into a rectangular shape of 30×150 mm and was then rubbed 100 times with a plain-woven cloth using a Gakushin-type fastness rubbing tester (load: 500 g), and a peeling degree of the ink was evaluated by visual inspection. Evaluation was performed by the following criteria, and the results are shown in Table 6.

AA: No peeling is observed.
A: Less than 20% of evaluation area is peeled off.
B: Less than 50% of evaluation area is peeled off.
C: 50% or more of evaluation area is peeled off.

### 4.4.5. Evaluation of Clogging Recovery Property

Under the recording test conditions, non-ejection was intentionally generated in nozzles. Under the condition described above, idle running was performed for 3 hours under the platen temperature condition shown in Table 6. After the recording was performed, cleaning was performed 3 times, and finally, the number of generated missing nozzles was evaluated. By one cleaning, 0.5 g of the ink was ejected from a nozzle line. In addition, the non-ejection nozzle was generated by patting a nozzle surface with a Bemcot cloth wet with water. The nozzle line was formed from 400 nozzles. In addition, the treatment liquid was not evaluated. Evaluation was performed by the following criteria, and the results are shown in Table 6.

AA: No-ejection nozzles are not confirmed.
A: No-ejection nozzles are less than 1%.
B: No-ejection nozzles are 1% to less than 3%.
C: No-ejection nozzles are 3% or more.

### 4.4.6. Evaluation of Storage Stability

After 30 g of each of the ink jet ink compositions thus prepared was sealed in an aluminum pack so as not to incorporate air bubbles, this aluminum pack was left in a temperature-constant bath at 60° C. for 6 days. After the aluminum pack was recovered from the bath and spontaneously cooled, a viscosity of the ink jet ink composition was measured at a shear rate of 200 sec⁻¹ using a rheometer (MCR702, manufactured by Anton Paar) and was compared with a viscosity thereof at an initial stage (immediately after the ink preparation) to obtain a viscosity increase rate. Evaluation was performed by the following criteria, and the results are shown in Tables 3 and 4.

A: viscosity increase rate of less than 3%

B: viscosity increase rate of 3% to less than 5%

C: viscosity increase rate of 5% or more

TABLE 6

| | EXAMPLE 1 | EXAMPLE 2 | EXAMPLE 3 | EXAMPLE 4 | EXAMPLE 5 |
|---|---|---|---|---|---|
| COLOR INK | INK A | INK B | INK C | INK J | INK K |
| TREATMENT LIQUID | — | — | — | — | — |
| SURFACE TEMPERATURE | 45° C. | 45° C. | 45° C. | 45° C. | 45° C. |
| ABRASION RESISTANCE | A | A | A | A | A |
| IMAGE QUALITY (COLOR | A | A | A | A | B |
| DEVELOPMENT) | | | | | |
| IMAGE QUALITY (AGGREGATION | A | A | A | A | B |
| IRREGULARITY) | | | | | |
| CLOGGING RECOVERY PROPERTY | A | B | B | A | A |
| | EXAMPLE 6 | EXAMPLE 7 | EXAMPLE 8 | EXAMPLE 9 | EXAMPLE 10 |
| COLOR INK | INK N | INK O | INK P | INK Q | INK R |
| TREATMENT LIQUID | — | — | — | — | — |
| SURFACE TEMPERATURE | 45° C. | 45° C. | 45° C. | 45° C. | 45° C. |
| ABRASION RESISTANCE | B | A | AA | B | A |
| IMAGE QUALITY (COLOR | A | B | A | AA | A |
| DEVELOPMENT) | | | | | |
| IMAGE QUALITY (AGGREGATION | A | A | A | A | A |
| IRREGULARITY) | | | | | |
| CLOGGING RECOVERY PROPERTY | B | B | B | A | A |
| | EXAMPLE 11 | EXAMPLE 12 | EXAMPLE 13 | EXAMPLE 14 | EXAMPLE 15 |
| COLOR INK | INK S | INK T | INK X | INK A | INK A |
| TREATMENT LIQUID | — | — | — | — | TREATMENT |
| | | | | | LIQUID A |
| SURFACE TEMPERATURE | 45° C. | 45° C. | 45° C. | 40° C. | 30° C. |
| ABRASION RESISTANCE | B | B | A | A | B |
| IMAGE QUALITY (COLOR | B | A | B | AA | B |
| DEVELOPMENT) | | | | | |
| IMAGE QUALITY (AGGREGATION | A | A | B | B | AA |
| IRREGULARITY) | | | | | |
| CLOGGING RECOVERY PROPERTY | A | AA | A | A | AA |
| | | | | COMPARATIVE | COMPARATIVE |
| | EXAMPLE 16 | EXAMPLE 17 | EXAMPLE 18 | EXAMPLE 1 | EXAMPLE 2 |
| COLOR INK | INK A | INK A | INK A | INK D | INK E |
| TREATMENT LIQUID | TREATMENT | TREATMENT | TREATMENT | — | — |
| | LIQUID B | LIQUID C | LIQUID A | | |
| SURFACE TEMPERATURE | 30° C. | 30° C. | 40° C. | 45° C. | 45° C. |
| ABRASION RESISTANCE | B | B | B | A | C |
| IMAGE QUALITY (COLOR | B | B | B | C | B |
| DEVELOPMENT) | | | | | |
| IMAGE QUALITY (AGGREGATION | AA | A | AA | B | A |
| IRREGULARITY) | | | | | |
| CLOGGING RECOVERY PROPERTY | AA | AA | A | A | A |
| | COMPARATIVE | COMPARATIVE | COMPARATIVE | COMPARATIVE | COMPARATIVE |
| | EXAMPLE 3 | EXAMPLE 4 | EXAMPLE 5 | EXAMPLE 6 | EXAMPLE 7 |
| COLOR INK | INK F | INK G | INK H | INK I | INK L |
| TREATMENT LIQUID | — | — | — | — | — |
| SURFACE TEMPERATURE | 45° C. | 45° C. | 45° C. | 45° C. | 45° C. |
| ABRASION RESISTANCE | A | A | A | C | A |
| IMAGE QUALITY (COLOR | C | C | C | C | C |
| DEVELOPMENT) | | | | | |
| IMAGE QUALITY (AGGREGATION | B | B | B | B | B |
| IRREGULARITY) | | | | | |
| CLOGGING RECOVERY PROPERTY | B | B | B | A | A |

| | COMPARATIVE | COMPARATIVE | COMPARATIVE | COMPARATIVE |
|---|---|---|---|---|
| | EXAMPLE 8 | EXAMPLE 9 | EXAMPLE 10 | EXAMPLE 11 |
| COLOR INK | INK M | INK U | INK V | INK W |
| TREATMENT LIQUID | — | — | — | — |
| SURFACE TEMPERATURE | 45° C. | 45° C. | 45° C. | 45° C. |
| ABRASION RESISTANCE | AA | A | C | C |
| IMAGE QUALITY (COLOR | C | C | B | A |
| DEVELOPMENT) | | | | |
| IMAGE QUALITY (AGGREGATION | B | B | A | B |
| IRREGULARITY) | | | | |
| CLOGGING RECOVERY PROPERTY | A | A | A | A |

### 4.5. Evaluation Results

According to the ink jet ink composition of each Example, which is a water-based ink including the colorant, the resin, the water-soluble low molecular weight organic compound A which is one of an amide, a sulfur-containing compound, and a cyclic ether and which satisfies the condition (a) and the condition (b), and the silicone-based surfactant which satisfies the condition (c), it was found that an image has excellent abrasion resistance and image quality. On the other hand, in each Comparative Example which is different from Example, it was found that an image has an inferior abrasion resistance or an inferior image quality.

The above embodiments and modified examples are described by way of example, and the present disclosure is not limited thereto. For example, the embodiments and the modified examples described above may be appropriately used in combination.

The present disclosure includes substantially the same structure as the structure described in the embodiment. That is, the substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

From the embodiments and modified examples described above, the following conclusions are obtained.

An ink jet ink composition which is a water-based ink, comprises: a colorant; a resin; a water-soluble low molecular weight organic compound A which is one of an amide, a sulfur-containing compound, and a cyclic ether and which satisfies the following condition (a) and condition (b); and a silicone-based surfactant which satisfies the following condition (c). The condition (a) is that a surface tension of an aqueous solution at a concentration of 10 percent by mass is 42 to 56 mN/m, the condition (b) is that a standard boiling point is 150° C. to 300° C., and the condition (c) is that a solubility in water at 20° C. is 1 percent by mass or less.

According to the ink jet ink composition described above, since the low molecular weight organic compound A satisfies the condition (a) and the condition (b), the clogging recovery property of nozzles is made preferable, and an image having preferable image quality and abrasion resistance can be obtained.

In the ink jet ink composition described above, a content of the low molecular weight organic compound A with respect to a total mass of the ink jet ink composition may be 1 to 10 percent by mass.

According to the ink jet ink composition described above, the clogging recovery property of nozzles is made more preferable, and an image having preferable image quality and abrasion resistance can be obtained.

The ink jet ink composition described above may be configured not to contain more than 9 percent by mass of an organic solvent having a surface tension of 35 mN/m or less in the form of an aqueous solution at a concentration of 10 percent by mass.

According to the ink jet ink composition described above, an image having a more preferable color development property can be formed.

In the ink jet ink composition described above, a content of the silicone-based surfactant with respect to the total mass of the ink jet ink composition may be 0.1 to 2 percent by mass.

According to the ink jet ink composition described above, the clogging recovery property of nozzles is made more preferable, and an image having preferable image quality and abrasion resistance can be obtained.

In the ink jet ink composition described above, the resin includes resin particles, and the resin particles may be formed from one of an acrylic-based resin, a polyurethane-based resin, and a polyester-based resin.

According to the ink jet ink composition described above, the clogging recovery property of nozzles is made more preferable, and an image having a preferable abrasion resistance can be obtained.

The ink jet ink composition described above may further comprise at least one organic solvent, and a total content of the organic solvent with respect to the total mass of the ink jet ink composition may be 5 to 30 percent by mass.

According to the ink jet ink composition described above, the clogging recovery property of nozzles is made more preferable, and an image having a preferable drying property can be obtained.

In the ink jet ink composition described above, when a total mass of a water-soluble low molecular weight organic compound which is one of an amide, a sulfur-containing compound, and a cyclic ether and which satisfies the condition (b) contained in the ink jet ink composition is assumed to be 100 percent by mass, a content of the low molecular weight organic compound A may be 80 percent by mass or more.

According to the ink jet ink composition described above, the clogging recovery property of nozzles is made more preferable, and an image having preferable image quality and abrasion resistance can be obtained.

The ink jet ink composition described above may be used for recording on a low-absorbing recording medium or a non-absorbing recording medium.

According to the ink jet ink composition described above, even if a low-absorbing recording medium or a non-absorbing recording medium is used, an image having preferable image quality and abrasion resistance can be obtained.

The ink jet ink composition described above may further comprise an anionic surfactant represented by the following general formula (1).

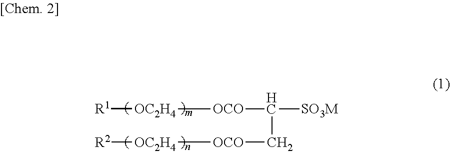

In the general formula (1), R¹ and R² each independently represent a hydrogen atom or a linear or branched alkyl group having 1 to 20 carbon atoms, m and n each independently represent an integer of 0 to 20, and M represents an atom to be formed into a monovalent cation.

According to the ink jet ink composition described above, by a synergetic effect of the anionic surfactant and the silicone-based surfactant, affinity to a recording medium is enhanced, and hence, an image having more preferable image quality and abrasion resistance can be obtained.

A recording method comprises: an ink adhesion step of adhering the ink jet ink composition described above to a recording medium by an ink jet method.

According to the recording method described above, an image having preferable image quality and abrasion resistance can be obtained.

In the recording method described above, the ink adhesion step may be performed when the recording medium has a surface temperature of 50° C. or less.

According to the recording method described above, an image having preferable image quality and abrasion resistance can be obtained with a more preferable drying property.

The recording method described above may further comprise: a primary heating step of heating the ink jet ink composition adhered to the recording medium.

According to the recording method described above, an image having preferable image quality and abrasion resistance can be obtained with a more preferable drying property.

The recording method described above may further comprise: a treatment liquid adhesion step of adhering a treatment liquid containing an aggregating agent to the recording medium.

According to the recording method described above, an image having a more preferable image quality can be obtained.

What is claimed is:

1. An ink jet ink composition which is a water-based ink, the ink composition comprising:
a colorant;
a resin;
a water-soluble low molecular weight organic compound A which is one of an amide, a sulfur-containing compound, and a cyclic ether and which satisfies the following condition (a) and condition (b); and
a silicone-based surfactant which satisfies the following condition (c),
wherein the condition (a) is that a surface tension of an aqueous solution at a concentration of 10 percent by mass is 42 to 56 mN/m,
the condition (b) is that a standard boiling point is 150° C. to 300° C., and
the condition (c) is that a solubility in water at 20° C. is 1 percent by mass or less.

2. The ink jet ink composition according to claim 1,
wherein a content of the low molecular weight organic compound A with respect to a total mass of the ink jet ink composition is 1 to 10 percent by mass.

3. The ink jet ink composition according to claim 1,
wherein the ink jet ink composition is configured not to contain more than 9 percent by mass of an organic solvent having a surface tension of 35 mN/m or less in the form of an aqueous solution at a concentration of 10 percent by mass.

4. The ink jet ink composition according to claim 1,
wherein a content of the silicone-based surfactant with respect to a total mass of the ink jet ink composition is 0.1 to 2 percent by mass.

5. The ink jet ink composition according to claim 1,
wherein the resin includes resin particles, and
the resin particles are formed from one of an acrylic-based resin, a polyurethane-based resin, and a polyester-based resin.

6. The ink jet ink composition according to claim 1,
further comprising at least one organic solvent,
wherein a total content of the organic solvent with respect to a total mass of the ink jet ink composition is 5 to 30 percent by mass.

7. The ink jet ink composition according to claim 1,
wherein when a total mass of a water-soluble low molecular weight organic compound which is one of an amide, a sulfur-containing compound, and a cyclic ether and which satisfies the condition (b) contained in the ink jet ink composition is assumed to be 100 percent by mass, a content of the low molecular weight organic compound A is 80 percent by mass or more.

8. The ink jet ink composition according to claim 1,
wherein the ink jet ink composition is used for recording on a low-absorbing recording medium or a non-absorbing recording medium.

9. The ink jet ink composition according to claim 1,
further comprising an anionic surfactant represented by the following general formula (1) 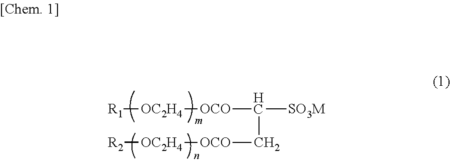
where in the general formula (1), R¹ and R² each independently represent a hydrogen atom or a linear or branched alkyl group having 1 to 20 carbon atoms, m and n each independently represent an integer of 0 to 20, and M represents an atom to be formed into a monovalent cation.

10. A recording method comprising:
an ink adhesion step of adhering the ink jet ink composition according to claim 1 to a recording medium by an ink jet method.

11. The recording method according to claim 10,
wherein the ink adhesion step is performed when the recording medium has a surface temperature of 50° C. or less.

12. The recording method according to claim 10, further comprising:
a primary heating step of heating the ink jet ink composition adhered to the recording medium.

13. The recording method according to claim 10, further comprising:
a treatment liquid adhesion step of adhering a treatment liquid containing an aggregating agent to the recording medium.
